(19) United States
(12) Patent Application Publication
(10) Pub. No.: US 2026/0002767 A1
(43) Pub. Date: Jan. 1, 2026

(54) MEASURING INSTRUMENT WITH ARC MOTION AND CORRECTION PROCESS

(71) Applicant: Mitutoyo Corporation, Kanagawa-ken (JP)

(72) Inventor: Ted Staton COOK, Kirkland, WA (US)

(21) Appl. No.: 18/759,001

(22) Filed: Jun. 28, 2024

(51) Int. Cl. G01B 3/22; G01B 3/00; G01B 21/04

(52) U.S. Cl. CPC G01B 3/22; G01B 3/004; G01B 21/045; G01B 21/047

(57) ABSTRACT

A measuring instrument includes a movable portion configured to rotate in an arc motion about a pivot portion, and an electronic position encoder configured to measure an absolute relative position between a detector portion and a scale portion, one of which forms part of the movable portion. A maximum movement range of the movable encoder portion and a maximum absolute measurement range are each less than 360 degrees. Based at least in part on detector signals that are received from the detector portion, an offset value is determined that corresponds to a radial offset (e.g., of the scale portion or the detector portion). The determined offset value is utilized to correct one or more values that are utilized to determine a relative position between the detector portion and the scale portion (e.g., such as a value corresponding to a spatial step or other spatial value of the scale portion).

### BACKGROUND

### Technical Field

This disclosure relates to metrology and, more particularly, to measuring instruments, such as may include a moving member (e.g., a stylus) that rotates about a pivot portion in an arc motion and for which corresponding measurements are determined by an electronic position encoder, and for which some examples of such measuring instruments include test indicators, lever-type dial indicators, lever-type dial gauges, etc.

### Description of the Related Art

Certain measuring instruments include a moveable member (e.g., including a stylus) that moves in an arc motion when utilized (e.g., for determining measurements of a workpiece that is being inspected). As an example, a test indicator (e.g., sometimes also referenced as a lever indicator, lever-type dial indicator, lever-type dial gauge, etc.) is described in U.S. Patent Publication No. 2022/0341733 (the '733 publication), which includes a stylus that rotates around a pivot portion with a corresponding rotation angle (e.g., in an arc motion). A rotation of the stylus results in a movement of a sector gear on an opposite side of the pivot portion, which correspondingly rotates an encoder that detects a rotation angle. As described, such test indicators may be utilized to inspect workpieces (e.g., with a contact point of the stylus pressed against a surface of the workpiece), such as for measuring minute displacements, such as circumferential flexure, total flexure, flatness, and parallelism, and for a precise comparison inspection, such as for determining a machining error of a machined workpiece, etc.

In certain implementations, it may be desirable for such measuring instruments to include encoders (e.g., for measuring such arc motions) that provide desirable combinations of features, such as combinations of compact size, high resolution, accuracy, low cost, robustness to contamination, etc. Configurations of encoders that provide improved combinations of such features in such measuring instruments would be desirable.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect, a measuring instrument is provided which includes a movable portion and an electronic position encoder. The movable portion is configured to rotate in an arc motion about a pivot portion, and includes a movable encoder portion MEP.

The electronic position encoder is configured to measure an absolute relative position between a detector portion and a scale portion, for example along an arc motion direction. The movable encoder portion MEP of the movable portion includes one of the detector portion or the scale portion. The scale portion extends along a scale direction, and includes a first scale element portion comprising first signal modulating scale elements; and a second scale element portion comprising second signal modulating scale elements. The detector portion is configured to be proximate to the scale portion with relative movement between the detector portion and the scale portion resulting from the arc motion of the movable encoder portion MEP. The detector portion includes a field generating portion configured to generate changing magnetic flux in response to drive signals; and a sensing portion. The sensing portion includes a first sensing element portion comprising a first set of first sensing elements and arranged in a first track portion with the first scale element portion; and a second sensing element portion comprising a first set of second sensing elements and arranged in a second track portion with the second scale element portion.

In various implementations, a maximum movement range of the arc motion of the movable encoder portion is less than 360 degrees, and the first scale element portion is arranged with a central reference point at a first radial distance RD1 from the pivot portion and the second scale element portion is arranged with a central reference point at a second radial distance RD2 from the pivot portion, wherein the ratio of RD1/RD2 is at least 1.4.

In accordance with another aspect, a method is provided for operating the measuring instrument including the movable portion and the electronic position encoder. The method includes generally two steps. The first step includes providing drive signals to cause the field generating portion to generate changing magnetic flux. The second step includes receiving detector signals from the detector portion, wherein the detector signals include: detector signals from the first set of first sensing elements that operate in conjunction with first signal modulating scale elements; and detector signals from the first set of second sensing elements that operate in conjunction with second signal modulating scale elements.

In various implementations, the measuring instrument also includes a signal processing configuration that is configured to: provide drive signals to cause the field generating portion of the detector portion to generate changing magnetic flux; receive detector signals from the detector portion, wherein the detector signals comprise: detector signals from the first set of first sensing elements that operate in conjunction with first signal modulating scale elements; and detector signals from the first set of second sensing elements that operate in conjunction with second signal modulating scale elements; based at least in part on the received detector signals, determine an offset value that corresponds to a radial offset of at least one of the scale portion or the detector portion; and utilize the determined offset value to correct one or more values that are utilized to determine a relative position between the detector portion and the scale portion.

In accordance with another aspect, a method is provided for operating the measuring instrument including the movable portion and an electronic position encoder. The method includes generally four steps. The first step includes providing drive signals to cause the field generating portion to generate changing magnetic flux. The second step includes receiving detector signals from the detector portion, wherein the detector signals comprise: detector signals from the first set of first sensing elements that operate in conjunction with first signal modulating scale elements; and detector signals from the first set of second sensing elements that operate in conjunction with second signal modulating scale elements. The third step includes, based at least in part on the received detector signals, determining an offset value that corresponds to a radial offset of at least one of the scale portion or the detector portion. The fourth step includes utilizing the determined offset value to correct one or more values that are utilized to determine a relative position between the detector portion and the scale portion.

According to a further aspect, the electronic position encoder is provided which is configured to measure an absolute relative position between the detector portion and the scale portion, for example along an arc motion direction. The electronic position encoder is configured to be utilized in the measuring instrument that comprises the movable portion configured to rotate in an arc motion about a pivot portion.

### BRIEF DESCRIPTION OF THE DRAWINGS

FIG. 1 is a diagram of a measuring instrument including an electronic position encoder with a transducer including a detector portion and a scale portion.

FIG. 2 is a diagram illustrating additional detail of one implementation of a measuring instrument such as that of FIG. 1.

FIG. 3A is a diagram of an implementation of a portion of a transducer configured to be utilized with arc motion between a detector portion and a scale portion such as may be utilized in the measuring instrument of FIG. 2 and having a first large separation of the scale tracks. FIG. 3B is an explanatory list of the references used in FIG. 3A.

FIG. 4 is a diagram illustrating certain dimensions and features of the measuring instrument of FIG. 2 and the transducer of FIG. 3A.

FIG. 5 is a diagram illustrating certain signals resulting from the operation of the transducer of FIGS. 3A and 4 with arc motion between the detector portion and the scale portion.

FIG. 6 is a diagram of an implementation of a portion of a transducer configured to be utilized with arc motion between a detector portion and a scale portion such as may be utilized in the measuring instrument of FIG. 2 and having a relatively smaller separation of the scale tracks in comparison to the implementation of FIG. 3A.

FIG. 7 is a diagram illustrating certain dimensions and features of the measuring instrument of FIG. 2 and the transducer of FIG. 6.

FIGS. 8A-8B are diagrams illustrating an offset in relation to certain features of FIGS. 6 and 7.

FIGS. 9A-9C are diagrams of graphs illustrating certain data resulting from the operations and a correction process of the transducer of FIGS. 6 and 7 with an offset such as that illustrated in FIGS. 8A-8B.

FIGS. 10A-10B are diagrams illustrating an offset in relation to certain features of FIGS. 3A and 4.

FIGS. 11A-11C are diagrams of graphs illustrating certain data resulting from the operations and a correction process of the transducer of FIGS. 3A and 4 with an offset such as that illustrated in FIGS. 10A-10B.

FIG. 12 is a diagram illustrating certain dimensions and features of the measuring instrument of FIG. 2 and a portion of a transducer configured to be utilized with arc motion between a detector portion and a scale portion such as may be utilized in the measuring instrument of FIG. 2 and having a second large separation of the scale tracks.

FIGS. 13A-13B are diagrams illustrating an offset in relation to certain features of FIG. 12.

FIGS. 14A-14C are diagrams of graphs illustrating certain data resulting from the operations and a correction process of the transducer of FIG. 12 with an offset such as that illustrated in FIGS. 13A-13B.

FIG. 15 is a diagram illustrating certain dimensions and features of the measuring instrument of FIG. 2 and a portion of a transducer configured to be utilized with arc motion between a detector portion and a scale portion such as may be utilized in the measuring instrument of FIG. 2 and having a third large separation of the scale tracks.

FIGS. 16A-16B are diagrams illustrating an offset in a first direction in relation to certain features of FIG. 15.

FIGS. 17A-17B are diagrams of graphs illustrating certain data resulting from the operations and a correction process of the transducer of FIG. 15 with an offset in the first direction such as that illustrated in FIGS. 16A-16B.

FIGS. 18A-18B are diagrams illustrating an offset in a second direction in relation to certain features of FIG. 15.

FIGS. 19A-19B are diagrams of graphs illustrating certain data resulting from the operations and a correction process of the transducer of FIG. 15 with an offset in the second direction such as that illustrated in FIGS. 18A-18B.

FIG. 20 is a flow diagram illustrating a method for operating a measuring instrument with arc motion for determining a relative position between a detector portion and a scale portion.

FIG. 21 is a flow diagram illustrating a method for a correction process for a measuring instrument with arc motion.

FIG. 22 is a plan view diagram schematically illustrating certain features of a representative prior art electronic position encoder configured to be utilized with linear motion between a detector portion and a scale portion, presented as background information that is relevant to various principles described herein.

### DETAILED DESCRIPTION

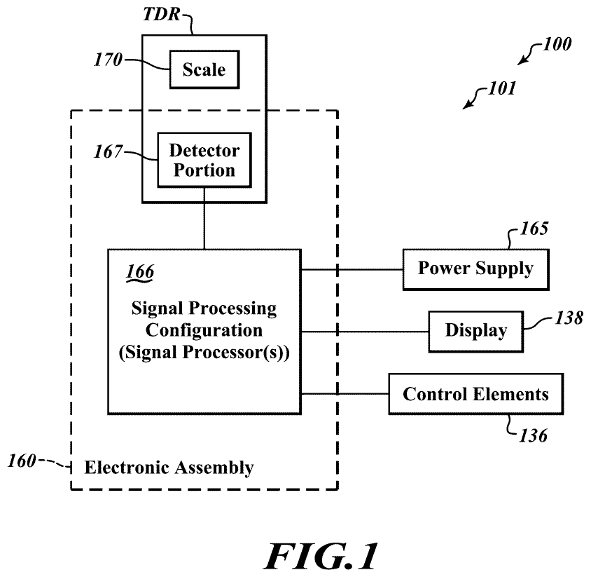

FIG. 1 is a block diagram of exemplary components of a measuring instrument 100 (e.g., a test indicator) including an electronic absolute position encoder 101. In various implementations, the electronic absolute position encoder 101 includes a scale portion 170 and a detector portion 167, which together form a transducer TDR. As will be described in more detail below, the encoder 101 as utilized herein is an absolute (ABS) position encoder utilizing two or more encoder tracks to provide absolute positioning (i.e., every position within the absolute range of the encoder 101 has a unique combination of signals). In general, ABS encoding may be more robust than incremental (INC) encoding (e.g., which counts increments while moving) and therefore more desirable for certain implementations (e.g., can tolerate power cycle without losing position, etc.). The measuring instrument 100 includes suitable user interface features such as a display 138 and/or user-operable control elements 136 (e.g., switches, buttons, etc.) The measuring instrument 100 may additionally include a power supply 165.

All of these elements of the measuring instrument 100 and/or encoder 101 are coupled to a signal processing configuration 166 (e.g., including one or more signal processors), which in various implementations may be embodied as a signal processing and display electronic circuit in integrated circuit (IC) chip(s). The signal processing configuration 166 receives detector signals from the detector portion 167 and processes the detector signals to determine an absolute position of the detector portion 167 along the scale portion 170. It will be appreciated that the signal processing configuration 166 may comprise any combination of signal processing and physical circuitry. In various implementations, the signal processing configuration 166 and the detector portion 167 may be included as part of an electronic assembly 160 (e.g., as arranged on a substrate, etc.)

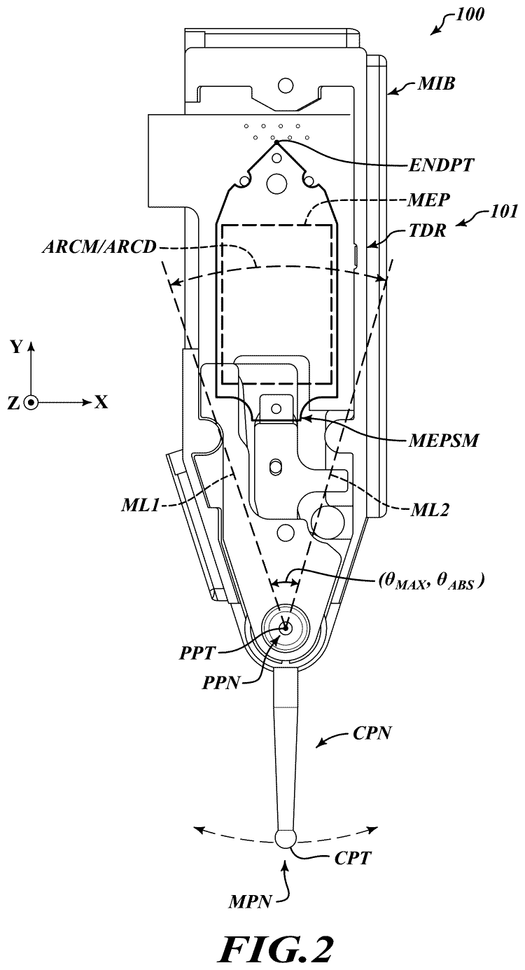

FIG. 2 is a diagram illustrating additional detail of one implementation of a measuring instrument 100 such as that of FIG. 1. As will be described in more detail below, the measuring instrument 100 includes an electronic position encoder 101, which includes a transducer TDR. In the example of FIG. 2, the measuring instrument 100 is a test indicator (e.g., sometimes also referenced as a lever indicator, lever-type dial indicator, lever-type dial gauge, etc.). In various implementations, certain aspects of the mechanical structure and operation of the measuring instrument 100 may be similar to that of certain prior test indicators, such as that described in the previously incorporated '733 publication.

As illustrated in FIG. 2, a contact portion CPN (e.g., a stylus) is coupled to and rotates around a pivot portion PPN (e.g., rotates around a pivot point PPT of the pivot portion PPN) with a corresponding angle (e.g., in an arc motion). The contact portion CPN includes a contact point CPT at an end thereof, such as may be utilized for contacting workpieces for performing measurement operations (e.g., such as for measuring displacements and/or dimensions, etc. of the workpiece). A measurement may be displayed on a digital display (e.g., display 138 of FIG. 1), such as may be mounted on a measuring instrument body MIB or other location of the measuring instrument 100. Certain control elements may also be provided (e.g., control elements 136 of FIG. 1) on the measuring instrument 100.

A moveable portion MPN of the measuring instrument 100 includes the contact portion CPN on a first side of the pivot portion PPN, and a moveable encoder portion support member MEPSM which supports a moveable encoder portion MEP on a second side of the pivot portion PPN. The moveable portion MPN is configured such that a workpiece measurement operation (e.g., for measuring a workpiece) that causes the contact portion CPN to rotate in relation to the pivot portion PPN (e.g., resulting from the contact point CPT contacting or otherwise moving along a surface of a workpiece) correspondingly causes the support member MEPSM and the moveable encoder portion MEP to rotate in an arc motion ARCM (e.g., in an arc motion direction ARCD). In the measuring instrument 100, a maximum angular movement range OMAX of the arc motion ARCM of the moveable encoder portion MEP is less than 360 degrees (e.g., and in some implementations, may be less than 90 degrees, or 45 degrees, or 15 degrees, etc.). Such relatively smaller angular movement ranges are typical for certain types of measuring instruments, in particular for applications where only relatively small deflections of the contact portion CPM (e.g., a stylus) are utilized for measuring a workpiece.

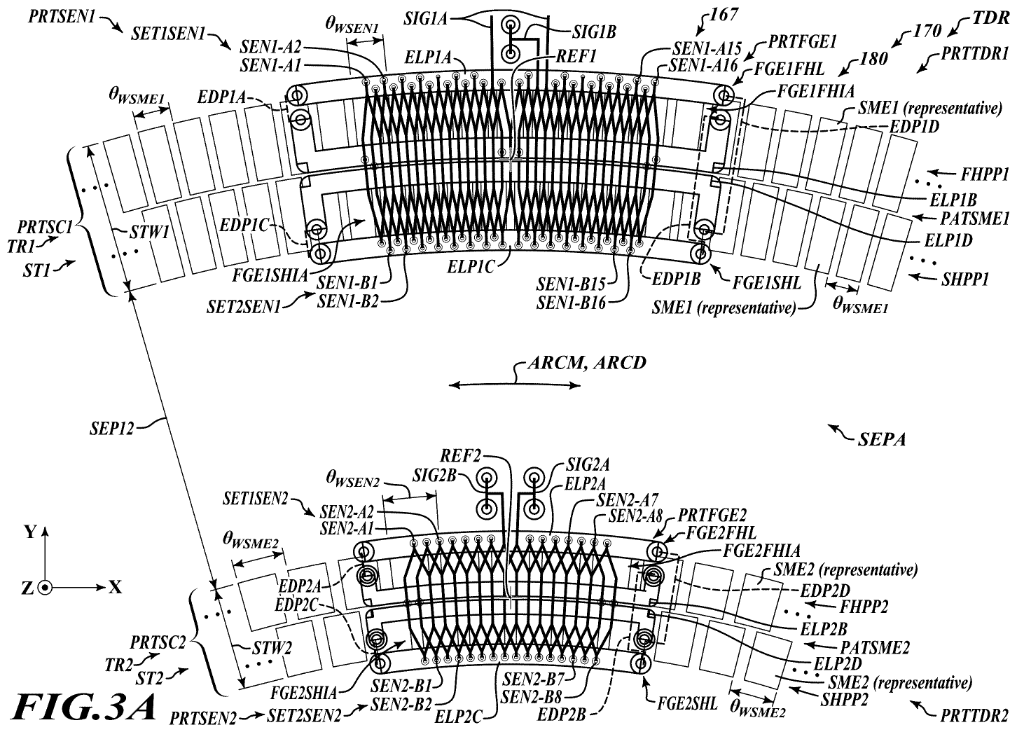

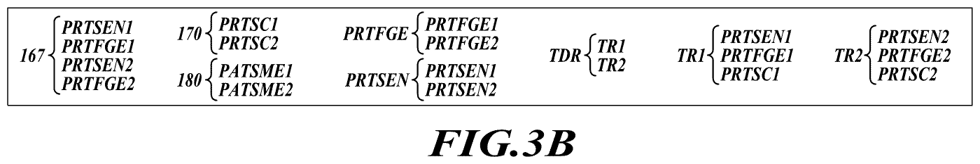

In various implementations, the moveable encoder portion MEP may include one of the detector portion 167 or the scale portion 170 (e.g., as described above with respect to FIG. 1, and as will be described in more detail below with respect to FIG. 3A). The other of the detector portion 167 or the scale portion 170 that is not included in the moveable encoder portion MEP is included in a fixed encoder portion FEP (not shown, but may be fixed to the measuring instrument body MIB for example) at a location proximate to the moveable encoder portion MEP. In one specific illustrative example, the movable encoder portion MEP may be arranged parallel with and facing the fixed encoder portion FEP, and a front face of the movable encoder portion MEP that faces the fixed encoder portion FEP may be separated from the fixed encoder portion FEP by a gap (e.g., on the order of 0.1 mm-0.2 mm) along the z-axis direction. Regardless of whether the detector portion 167 is included in the movable encoder portion MEP or the fixed encoder portion FEP, the front face of the detector portion 167 (e.g., including its constituent conductors) may be covered by an insulative coating.

In the orientation of FIG. 2, the fixed encoder portion FEP may be located directly beneath the moveable encoder portion MEP (and thus is not visible in FIG. 2). The fixed encoder portion FEP and the moveable encoder portion MEP (e.g., which are noted to include the detector portion 167 and the scale portion 170) correspondingly form the transducer TDR. As described above, relative movement between the moveable encoder portion MEP and the fixed encoder portion FEP (i.e., which corresponds to relative movement between the detector portion 167 and the scale portion 170) results from movement of the moveable encoder portion MEP in the arc motion direction ARCD, as resulting from movements of the contact portion CPN (e.g., as part of workpiece measurement operations).

As shown in FIG. 2, first and second movement limit indicators ML1 and ML2 are illustrated as dotted lines, which indicate a maximum movement range of the arc motion ARCM (e.g., including of the moveable encoder portion MEP) and as corresponding to the maximum angular movement range θ_{MAX}. The electronic position encoder 101 is an absolute position encoder which utilizes two or more encoder tracks (e.g., see FIG. 3A) to provide absolute positioning (i.e., for which every position has a unique combination of signals), as corresponding to an absolute angular measurement range θ_{ABS}, as will be described in more detail below. In the example of FIG. 2, the absolute angular measurement range θ_{ABS} is indicated as being approximately equal to the maximum angular movement range θ_{MAX}, although it will be appreciated that in alternative implementations, the absolute angular measurement range θ_{ABS} and the maximum angular movement range θ_{MAX} may be different (e.g., in most such implementations with the absolute angular measurement range θ_{ABS} being larger than the maximum angular movement range θ_{MAX}, and in all cases with the absolute angular measurement range θABS being less than 360 degrees). It will be appreciated that for certain implementations, the absolute angular measurement range θ_{ABS} and the maximum angular movement range θ_{MAX} are shown in the example of FIG. 2 for purposes of illustration and may not be to scale.

An endpoint ENDPT at the end of the moveable encoder portion support member MEPSM also corresponds to an endpoint of the moveable portion MPN. The endpoint ENDPT is at an opposite end of the moveable portion MPN in relation to the contact point CPT at the end of the contact portion CPN. As referenced herein, the contact portion CPN and the contact point CPT are on a first side of the pivot portion PPN, and the support member MEPSM, moveable encoder portion MEP and endpoint ENDPT are on a second side of the pivot portion PPN.

It will be appreciated that the measuring instrument of FIGS. 1 and 2 is one of various applications that typically implement an electronic position encoder that has evolved over a number of years to provide a relatively optimized combination of compact size, low power operation (e.g., for long battery life), high resolution and high accuracy measurement, low cost, robustness to contamination, etc. Even small improvements in any of these factors in any of these applications are highly desirable, but difficult to achieve, especially in light of the design constraints imposed in order to achieve commercial success in the various applications. The principles disclosed herein provide improvements in certain of these factors for various applications.

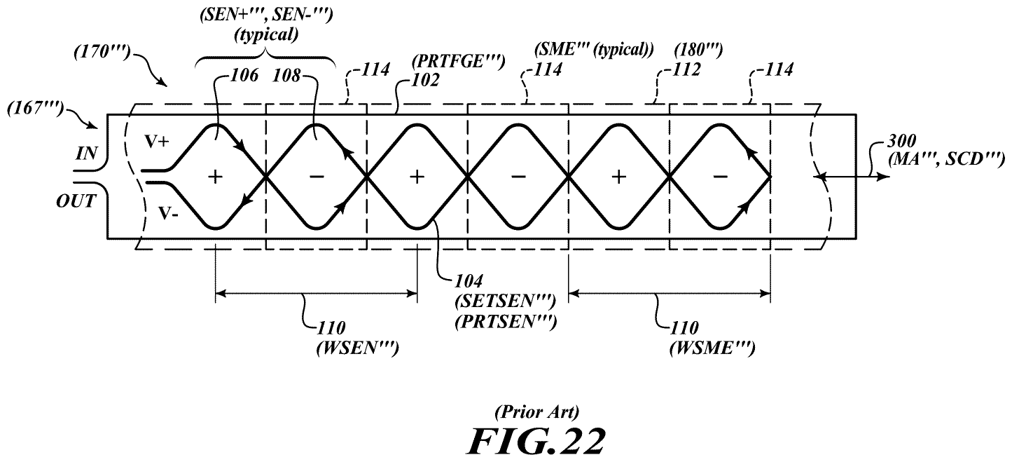

FIG. 22 is a plan view diagram schematically illustrating certain features of a representative prior art inductive electronic position encoder shown in U.S. Pat. No. 6,011,389 (the '389 patent), which is hereby incorporated herein by reference in its entirety, and which is presented as background information that is relevant to various principles disclosed elsewhere herein. FIG. 22 furthermore includes reference numeral annotations to show the comparable reference numerals or symbols used to designate comparable elements in other figures included herein. In the following abbreviated description, which is based on the disclosure of the '389 patent, some of the comparable reference numbers or symbols in other figures of the present disclosure are shown in parentheses proximate to the original reference numerals from the '389 patent. A full description related to the prior art FIG. 22 may be found in the '389 patent. Therefore, only an abbreviated description (e.g., including certain teachings from the '389 patent that are relevant to the present disclosure) is included here.

As disclosed in the '389 patent, a transducer such as that shown in FIG. 22 includes at least two substantially coplanar paths of wire or windings. A transmitter winding 102 (PRTFGE′″) forms a large planar loop. In this example, the transmitter winding 102 forms an entire field generating portion PRTFGE′″. A receiver winding 104 (PRTSEN′″, SETSEN′″), in substantially the same plane as the transmitter winding 102, is laid out in one direction as indicated by the arrows in a zig-zag or sinusoidal pattern and then in a reverse direction as indicated by the arrows so that the winding crosses over itself to form alternating loops 106 (SEN+′″) and 108 (SEN−′″) interposed between each other, as shown. As a result, each of the alternating loops 106 (SEN+′″) and 108 (SEN−′″) of the receiver winding 104 (PRTSEN′″, SETSEN′″) have a different winding direction as compared to adjacent loops. By applying an alternating (changing) current to the transmitter winding 102 (PRTFGE′″), the transmitter winding produces a time-varying magnetic field (a changing magnetic flux), extending through the loops 106 (SEN+′″) and 108 (SEN−′″) of the receiver winding 104 (PRTSEN′″, SETSEN′″). In various implementations, the loops 106 (SEN+′″) and 108 (SEN−′″) may be designated as a set of sensing elements (SETSEN′″) of a sensing portion (PRTSEN′″).

If a scale portion (170′″) or scale pattern 112 (180′″) (a segment of which is outlined by edges indicating alternating long-dash lines and short-dash lines in FIG. 22), including a conductive object (e.g., a signal modulating element such as a conductive plate 114 (SME′″), several of which are outlined using short-dash lines on the scale pattern 112 in FIG. 22), is moved close (proximate) to the detector portion (167′″), the varying magnetic field generated by the transmitter winding 102 (PRTFGE′″) will induce eddy currents in the conductive object, which in turn sets up a magnetic field from the object that counteracts the varying transmitter magnetic field (the changing magnetic flux). As a result, the magnetic flux that the receiver winding 104 (PRTSEN′″) receives is altered or disrupted, thereby causing the receiver winding to output a non-zero EMF signal (a voltage) at the output terminals V+ and V− of the receiver winding 104, which will change polarity as the conductive object moves between the “+” and “−” loops 106 (SEN+′″) and 108 (SEN−′″).

The distance between the location of two loops of the same polarity, (e.g., between the location of a loop 106 (SEN+′″) to the location of the next loop 106 (SEN+′″)) is defined as a linear spatial step (e.g., which may also be referenced as a pitch or wavelength) 110 (WSEN′″) of the set of sensing elements (SETSEN′″), and in certain implementations may be equal to a linear spatial step (e.g., which may also be referenced as a pitch or wavelength) 110 (WSME′″) of the scale pattern (180′″) of the scale portion (170′″) as disposed along the scale direction SCD′″ and/or measuring axis direction MA′″. It may be seen that each loop 106 (SEN+′″) and/or 108 (SEN−′″) therefore has a length or maximum dimension 0.5*(WSEN′″) along the measuring axis direction (MA′″), which may also be referenced as the scale direction SCD′″. If the conductive object described above (e.g., a conductive plate 114 (SME′″)) is proximate to the receiver winding 104 (PRTSEN′″) and is continuously varied in position along a measuring axis 300 (MA′″), the AC amplitude of the signal output from the receiver winding (PRTSEN′″) will vary continuously and periodically with the linear spatial step (e.g., which may also be referenced as a pitch or wavelength) 110 (WSME′″) due to the periodic alteration of the loops 106 (SEN+′″) and 108 (SEN−′″) and local disruption of the transmitted magnetic field caused by the conductive object (e.g., a conductive plate 114 (SME′″)). The signal output from the receiver winding (PRTSEN′″) may thus be utilized (e.g., processed) to indicate a relative position between the detector portion (167′″) and the scale portion (170′″). It will be appreciated that the transmitter winding 102 (PRTFGE′″) and the receiver winding 104 (PRTSEN′″) shown in FIG. 22 and described above are one example of a prior art implementation of elements that are designated as a detector portion (167′″).

FIG. 3A is a diagram of an implementation of a portion of a transducer TDR configured to be utilized with arc motion ARCM between a detector portion 167 and a scale portion 170, such as may be utilized in the electronic position encoder 101 of the measuring instrument 100 of FIGS. 1 and 2. The transducer TDR utilizes two track portions TR1 and TR2 as illustrated in FIG. 3A. FIG. 3B is an explanatory list of the references used in FIG. 3A.

It will be appreciated that certain aspects of the field generating elements and sensing elements of a detector portion (e.g., detector portion 167, etc.) as described herein may operate and be understood based at least in part on principles as described above with respect to FIG. 22. In the implementation of FIG. 3A, the scale portion 170, the detector portion 167 and a signal processing configuration 166 (e.g., of FIGS. 1 and 2) work cooperatively to provide the electronic position encoder 101 that is usable to measure a relative position between two elements (e.g., between the detector portion 167 and the scale portion 170 and/or elements attached thereto), such as along an arc motion direction. In various implementations, the detector portion 167 is formed on a detector substrate, and the scale portion 170 including the periodic scale pattern 180 is formed on a scale substrate, and for which measurement operations include relative movements between the two substrates (e.g., which may be relatively planar and parallel to one another). In various implementations, the detector portion 167 and the scale portion 170 may generally be in respective planes that extend along the x-axis direction and the y-axis direction, with a z-axis direction being orthogonal to the planes.

In various implementations, the scale portion 170 extends along the scale direction SCD and includes a first scale element portion PRTSC1 including first signal modulating elements SME1 and a second scale element portion PRTSC2 including second signal modulating element SME2. The first signal modulating elements SME1 are disposed along the scale direction SCD according to, and thus form, a first signal modulating element pattern PATSME1. The second signal modulating elements SME2 are disposed along the scale direction SCD according to, and thus form, a second signal modulating element pattern PATSME2. The first signal modulating element pattern PATSME1 and the second signal modulating element pattern PATSME2 are respective parts of a periodic scale pattern 180 of the scale portion 170. In various implementations, the periodic scale pattern 180 may alternatively be referred to as a signal modulating pattern 180. In various implementations, the first and/or second signal modulating elements SME1 and SME2 (i.e., as included in the first and second scale element portions PRTSC1 and PRTSC2) may be fabricated on a scale substrate (e.g., using known printed circuit fabrication methods).

The relative movement between the detector portion 167 and the scale portion 170 (e.g., in an arc motion direction) may indicate relative positions and/or measurements (e.g., in relation to the relative positions between the detector portion 167 and the scale portion 170). As described above with respect to FIGS. 1 and 2, a measured relative position or dimension may be displayed on a display 138 (e.g., a digital display). In various implementations, control elements 136 such as an on/off switch and other optional control buttons may be included.

As shown in FIG. 3A, the detector portion 167 may include a field generating portion PRTFGE and a sensing portion PRTSEN arranged along the scale direction SCD. In various implementations, in relation to the sensing portion PRTSEN, the scale direction SCD may also or alternatively be referred to as a sensing portion direction SPD. The field generating portion PRTFGE includes a first field generating element portion PRTFGE1 and a second field generating element portion PRTFGE2. The sensing portion PRTSEN includes a first sensing element portion PRTSEN1 and a second sensing element portion PRTSEN2. As will be described in more detail below, the first sensing element portion PRTSEN1 is configured to operate in conjunction with the first field generating element portion PRTFGE1 and the first scale element portion PRTSC1 as part of a first track portion TR1, and the second sensing element portion PRTSEN2 is configured to operate in conjunction with the second field generating element portion PRTFGE2 and the second scale element portion PRTSC2 as part of a second track portion TR2.

In various implementations, the field generating portion PRTFGE may include a number of elongated portions ELP and end portions EDP. The elongated portions may generally extend along, and thus be parallel to, the scale direction SCD, while the end portions may generally be transverse (e.g., perpendicular) to the scale direction SCD. The elongated portions ELP and end portions EDP in combination may form areas (e.g., in which changing magnetic flux may be generated by current flow through the elongated portions and end portions that results from drive signals) and for which the areas may include certain of the sensing elements.

In various implementations, the field generating portion PRTFGE may include first and second field generating element portions PRTFGE1 and PRTFGE2. The first field generating element portion PRTFGE1 is configured to operate in conjunction with the first sensing element portion PRTSEN1 and with first signal modulating elements SME1 of the first scale element portion PRTSC1. The first field generating element portion PRTFGE1 includes elongated portions ELP1A, ELP1B, ELP1C, ELP1D and end portions EDP1A, EDP1B, EDP1C, EDP1D (e.g., which in some implementations may be regarded as forming two field generating element loops, such as in a figure-8 configuration, and/or otherwise as a single field generating element loop that forms two loops in such a configuration as to form two interior areas). More specifically, the elongated portions ELP1A and ELP1B and end portions EDP1A and EDP1D may be regarded as forming a first field generating element first half loop FGE1FHL with an interior area FGE1FHIA. The first field generating element first half interior area FGE1FHIA is configured to be aligned with the first half pattern portion FHPP1 of the first scale element portion PRTSC1. The elongated portions ELP1C and ELP1D and end portions EDP1C and EDP1B may be regarded as forming a first field generating element second half loop FGE1SHL with an interior area FGE1SHIA. The first field generating element second half interior area FGE1SHIA is configured to be aligned with the second half pattern portion SHPP1 of the first scale element portion PRTSC1.

In various implementations, an end portion EDP (e.g., or other part of the first field generating element portion PRTFGE1) may include a port or other connection configuration. For example, the end portion EDP1B may be divided into two parts, such as with two contact points provided. The contact points may be used to receive drive signals and may be provided at locations where signal lines/circuit traces from the processing portion 166 may connect, etc. In various implementations, such a port may be representative of a general connection configuration, such as coupled to field generating drive electronics. Such field generating drive electronics may in various implementations include electronic components such as capacitors, transistors, etc., and as may be at least partially or fully included in or coupled to the processing portion 166, to provide the drive signals for causing the first field generating element portion PRTFGE1 to generate changing magnetic flux.

During operations, alternating current may be provided, although in order to simplify the following description only one direction of current is described (e.g., for purposes of example of one direction and/or as may occur in configurations where diodes or other components/configurations are provided to limit the current flow to one direction). As one example, current (e.g., as provided by drive signals), may flow through the following sequence of portions (e.g., in the following order for current in one direction), including: end portion EDP1D; elongated portion ELP1A; end portion EDP1A; elongated portion ELP1B; and end portion EDP1B; elongated portion ELP1C; end portion EDP1C; and elongated portion ELP1D. In accordance with this example of current flow, it will be appreciated that the current flow is in the same direction (e.g., left to right in the illustration of FIG. 3A) through the elongated portions (i.e., elongated portions ELP1A and ELP1C) at the outer boundaries of the configuration, and is in the same direction (i.e., right to left in the illustration of FIG. 3A) through the elongated portions (i.e., elongated portions ELP1B and ELP1D) in the middle of the configuration. This also corresponds to current flow around the first field generating element first half loop FGE1FHL in a counter-clockwise direction, and current flow around the first field generating element first half loop FGE1SHL in a clockwise direction (i.e., for which the directions of current flow through the respective loops are noted to be opposite, with corresponding opposite polarities of the resulting magnetic flux from each respective loop).

Such directions/orientations/polarities of current flow and corresponding magnetic flux may be advantageous for certain configurations, such as resulting in generated signals in first sensing elements SEN1 (e.g., such as at least partially aligned with the interior areas FGE1FHIA and FGE1SHIA of the first field generating element portion PRTFGE1). As one aspect, it is noted that in relation to the opposite directions of current flow and corresponding opposite polarities of the magnetic flux generated by the respective loops FGE1FHL and FGE1SHL, the spatially offset first and second half pattern portions FHPP1 and SHPP1 will result in detector signals (i.e., from the first sensing element portion PRTSEN1) that indicate the position of the first sensing element portion PRTSEN1 relative to the first scale element portion PRTSC1.

The second field generating element portion PRTFGE2 is configured to operate in conjunction with the second sensing element portion PRTSEN2 and with second signal modulating elements SME2 of the second scale element portion PRTSC2. The second field generating element portion PRTFGE2 includes elongated portions ELP2A, ELP2B, ELP2C, ELP2D and end portions EDP2A, EDP2B, EDP2C, EDP2D (e.g., which in some implementations may be regarded as forming two field generating element loops, such as in a figure-8 configuration, and/or otherwise as a single field generating element loop that forms two loops in such a configuration as to form two interior areas). More specifically, the elongated portions ELP2A and ELP2B and end portions EDP2A and EDP2D may be regarded as forming a second field generating element first half loop FGE2FHL with an interior area FGE2FHIA. The second field generating element first half interior area FGE2FHIA is configured to be aligned with the first half pattern portion FHPP2 of the second scale element portion PRTSC2. The elongated portions ELP2C and ELP2D and end portions EDP2C and EDP2B may be regarded as forming a second field generating element second half loop FGE2SHL with an interior area FGE2SHIA. The second field generating element second half interior area FGE2SHIA is configured to be aligned with the second half pattern portion SHPP2 of the second scale element portion PRTSC2.

In various implementations, an end portion EDP (e.g., or other part of the second field generating element portion PRTFGE2) may include a port or other connection configuration. For example, the end portion EDP2B may be divided into two parts, such as with two contact points provided. The contact points may be used to receive drive signals and may be provided at locations where signal lines/circuit traces from the processing portion 266 may connect, etc. In various implementations, such a port may be representative of a general connection configuration, such as coupled to field generating drive electronics. Such field generating drive electronics may in various implementations include electronic components such as capacitors, transistors, etc., and as may be at least partially or fully included in or coupled to the processing portion 266, to provide the drive signals for causing the second field generating element portion PRTFGE2 to generate changing magnetic flux.

During operations, alternating current may be provided, although in order to simplify the following description only one direction of current is described (e.g., for purposes of example of one direction and/or as may occur in configurations where diodes or other components/configurations are provided to limit the current flow to one direction). As one example, current (e.g., as provided by drive signals), may flow through the following sequence of portions (e.g., in the following order for current in one direction), including: end portion EDP2D; elongated portion ELP2A; end portion EDP2A; elongated portion ELP2B; and end portion EDP2B; elongated portion ELP2C; end portion EDP2C; and elongated portion ELP2D. In accordance with this example of current flow, it will be appreciated that the current flow is in the same direction (e.g., left to right in the illustration of FIG. 3A) through the elongated portions (i.e., elongated portions ELP2A and ELP2C) at the outer boundaries of the configuration, and is in the same direction (i.e., right to left in the illustration of FIG. 3A) through the elongated portions (i.e., elongated portions ELP2B and ELP2D) in the middle of the configuration. This also corresponds to current flow around the second field generating element first half loop FGE2FHL in a counter-clockwise direction, and current flow around the second field generating element first half loop FGE2SHL in a clockwise direction (i.e., for which the directions of current flow through the respective loops are noted to be opposite, with corresponding opposite polarities of the resulting magnetic flux from each respective loop).

Such directions/orientations/polarities of current flow and corresponding magnetic flux may be advantageous for certain configurations, such as resulting in generated signals in second sensing elements SEN2 (e.g., such as at least partially aligned with the interior areas FGE2FHIA and FGE2SHIA of the second field generating element portion PRTFGE2). As one aspect, it is noted that in relation to the opposite directions of current flow and corresponding opposite polarities of the magnetic flux generated by the respective loops FGE2FHL and FGE2SHL, the spatially offset first and second half pattern portions FHPP2 and SHPP2 will result in detector signals (i.e., from the second sensing element portion PRTSEN2) that indicate the position of the second sensing element portion PRTSEN2 relative to the second scale element portion PRTSC2.

As noted above, the sensing portion PRTSEN includes the first and second sensing element portions PRTSEN1 and PRTSEN2 (e.g., with each including respective sensing elements SEN1 and SEN2). In the illustrated implementation, the sensing elements SEN1 and SEN2 comprise sensing loop elements (alternatively referred to as sensing coil elements or sensing winding elements) which are connected in series and are generally transverse (e.g., nominally perpendicular) relative to the scale direction SCD. The first sensing element portion PRTSEN1 includes a first set of first sensing elements SET1SEN1 and a second set of first sensing elements SET2SEN1. The second sensing element portion PRTSEN2 includes a first set of second sensing elements SET1SEN2 and a second set of second sensing elements SET2SEN2. In the illustrated implementation, adjacent loop elements (e.g., conductive loops) in each respective set of sensing elements are connected by a configuration of conductors on various layers of PCB (e.g., connected by feedthroughs which in some implementations may include conductors passing through micro-vias, which may also be referenced as blind vias or buried vias) according to known methods. For example, the adjacent sensing elements SEN1 in each set of the first sensing element portion PRTSEN1, and the adjacent sensing elements SEN2 in each set of the second sensing element portion PRTSEN2, may have opposite winding polarities (e.g., with the sensing elements in each respective set alternating between SEN+ and SEN−, such as described above with respect to FIG. 22). That is, if a first loop corresponding to a sensing element responds to a changing magnetic field with a positive polarity detector signal contribution, then the adjacent loops corresponding to adjacent sensing elements respond with a negative polarity detector signal contribution. Loops having a positive polarity detector signal contribution may be designated SEN+ sensing elements herein, and loops having a negative polarity detector signal contribution may be designated SEN− sensing elements in various contexts herein. In various implementations, the sensing elements in each respective set are connected in series such that their detector signals or signal contributions are summed per set, and a “summed” detector signal is output at detector signal output connections (e.g., at the connections for each of the signals SIG1A and SIG1B, and SIG2A and SIG2B) to a signal processing configuration 166 (e.g., of FIG. 1).

In the illustrated implementation, the first set of first sensing elements SET1SEN1 includes sixteen first sensing elements SEN1 (i.e., including first sensing elements SEN1-A1 to SEN1-A12), and the second set of first sensing elements SET2SEN1 includes sixteen first sensing elements SEN1 (i.e., including first sensing elements SEN1-B1 to SEN1-B12). For simplicity of the illustration, only the first two (i.e., A1-A2 and B1-B2) and last two (i.e., A15-A16 and B15-B16) sensing elements of each set are labeled, although the sensing elements (i.e., A3-A14 and B3-B14) will similarly be understood to correspond to the remaining sensing elements as shown. In the illustrated implementation, the first set of second sensing elements SET1SEN2 includes eight second sensing elements SEN2 (i.e., including second sensing elements SEN2-A1 to SEN2-A8), and the second set of second sensing elements SET2SEN2 includes eight second sensing elements SEN2 (i.e., including second sensing elements SEN2-B1 to SEN2-B6). For simplicity of the illustration, only the first two (i.e., A1-A2 and B1-B2) and last two (i.e., A7-A8 and B7-B8) sensing elements of each set are labeled, although the sensing elements (i.e., A3-A6 and B3-B6) will similarly be understood to correspond to the remaining sensing elements as shown.

It will be appreciated that in various implementations it is advantageous to configure the detector (e.g., in each of the first and second sensing element portions PRTSEN1 and PRTSEN2) to provide two or more sets of sensing elements at different spatial phase positions (e.g., to provide or otherwise correspond to quadrature signals, etc.), as will be understood by one of ordinary skill in the art. Thus, for example, the first set of first sensing elements SET1SEN1 and the second set of first sensing elements SET2SEN1 are at different spatial phase positions. Similarly, the first set of second sensing elements SET1SEN2 and the second set of second sensing elements SET2SEN2 are at different spatial phase positions. However, it should be appreciated that the configurations of sensing elements as described herein are intended to be exemplary only, and not limiting. As one example, individual sensing element loops may output individual signals to a corresponding signal processing configuration in some implementations, for example as disclosed in U.S. Pat. No. 9,958,294, which is hereby incorporated by reference in its entirety. More generally, various known sensing element configurations may be used in combination with the principles described herein, for use in combination with various scale pattern and signal processing schemes, etc.

In the illustrated implementation of the scale portion 170 and the scale pattern 180, the first signal modulating element pattern PATSME1 in the first scale element portion PRTSC1 in the first track portion TR1 includes a first half pattern portion FHPP1 and a second half pattern portion SHPP2, with each half pattern portion including a row of first signal modulating elements SME1. Similarly, the second signal modulating element pattern PATSME2 in the second scale element portion PRTSC2 in the second track portion TR2 includes a first half pattern portion FHPP2 and a second half pattern portion SHPP2, with each half pattern portion including a row of second signal modulating elements SME2.

In various implementations, the signal modulating elements SME1 and/or SME2 may comprise conductive plates (e.g., as formed by regions fabricated on a printed circuit board, or as formed by raised regions extending from a conductive substrate, or as fabricated on a glass substrate, or according to other fabrication methods, etc.). The scale pattern 180 is generally implemented on the scale portion 170. It will be appreciated that there is relative movement between the scale pattern 180 and the detector portion 167 (e.g., along an arc motion direction) during operation. The scale pattern 180 has spatial characteristics which change as a function of position, so as to provide position dependent detector signals arising in the sensing elements SEN1 and SEN2 of the sensing portion PRTSEN in the detector portion 167. In various implementations, the field generating portion PRTFGE and the sensing portion PRTSEN of the detector portion 167 may be formed according to a variety of alternative configurations to be used in combination with a variety of corresponding signal processing schemes, as will be understood by one skilled in the art.

In one specific illustrative example, the detector portion 167 may be arranged parallel with and facing the scale portion 170, and a front face of the detector portion 167 that faces the scale portion 170 may be separated from the scale portion 170 (and/or the scale pattern 180) by a gap distance (e.g., on the order of 0.1 mm-0.2 mm) along the z-axis direction. The front face of the detector portion 167 (e.g., including its constituent conductors) may be covered by an insulative coating.

It will be appreciated that various elements may reside on different fabrication layers located at different planes along the z-axis direction, as needed to provide various operating gaps and/or insulating layers, as will be apparent to one of ordinary skill in the art based on the described implementations and the incorporated references. Throughout the figures of this disclosure, it will be appreciated that the illustrated x-axis, y-axis and/or z-axis dimensions of one or more elements may be exaggerated for clarity, but it will be understood that they are not intended to contradict the various design principles and relationships described herein.

The transducer TDR includes a first transducer portion PRTTDR1 and a second transducer portion PRTTDR2. The first transducer portion PRTTDR1 includes the first sensing element portion PRTSEN1, the first field generating element portion PRTFGE1, and the first scale element portion PRTSC1. The second transducer portion PRTTDR2 includes the second sensing element portion PRTSEN2, the second field generating element portion PRTFGE2, and the second scale element portion PRTSC2. The first and second track portions TR1 and TR2 include the first transducer portion PRTTDR1 and the second transducer portion PRTTDR2, respectively. As described herein, operations of the first transducer portion PRTTDR1 of the first track portion TR1 produce detector signals SIG1A and SIG1B and operations of the second transducer portion PRTTDR2 of the second track portion TR2 produce detector signals SIG2A and SIG2B. Processing of the signals (e.g., by the signal processing configuration 166) enables an absolute relative position to be determined between the detector portion 167 and the scale portion 170.

The first transducer portion PRTTDR1 of the first track portion TR1 and the second transducer portion PRTTDR2 of the second track portion TR2 may be operated in accordance with first and second drive operations, respectively, which in various implementations may be performed simultaneously or with different timings. As part of a first drive operation, the first field generating element portion PRTFGE1 generates a changing magnetic flux in response to a coil drive signal (e.g., as provided from a signal processing configuration 166). The first sensing elements SEN1 of the first sensing element portion PRTSEN1 are configured to provide detector signals (e.g., SIG1A, SIG1B) which respond to a local effect on the changing magnetic flux provided by first signal modulating elements SME1 (e.g., including first signal modulating elements SME1 that are relatively adjacent or otherwise aligned with sensing elements SEN1 along the z-axis direction) of the first scale element portion PRTSC1. As part of a second drive operation, the second field generating element portion PRTFGE2 generates a changing magnetic flux in response to a coil drive signal (e.g., as provided from a signal processing configuration 166). The second sensing elements SEN2 of the second sensing element portion PRTSEN2 are configured to provide detector signals (e.g., SIG2A and SIG2B) which respond to a local effect on the changing magnetic flux provided by second signal modulating elements SME2 (e.g., including second signal modulating elements SME2 that are relatively adjacent or otherwise aligned with sensing elements SEN2 along the z-axis direction) of the second scale element portion PRTSC2.

A signal processing configuration (e.g., the signal processing configuration 166 of FIG. 1, etc.) may be configured to determine a position of the sensing portion PRTSEN (e.g., including the first and second sensing element portions PRTSEN1 and PRTSEN2) of the detector portion 167 relative to the scale portion 170 based on the detector signals input from the detector portion 167. For example, the first sensing element portion PRTSEN1 may provide detector signals SIG1A and SIG1B, and the second sensing element portion PRTSEN2 may provide detector signals SIG2A and SIG2B. In various implementations, the detector signals may also or alternatively be referenced as sensing signals. The signals from the detector portion 167 may be input to the signal processing configuration 166, and utilized for determining the measurement/position of the detector portion 167 relative to the scale portion 170. In general, the sensing element portions and field generating element portions may at least in part operate according to known principles (e.g., for inductive encoders), such as those described above in relation to FIG. 22, and such as described at least in part in U.S. Pat. Nos. 5,841,274; 5,886,519; 5,894,678; 6,124,708; 10,520,335; 10,612,943 and 10,775,199, each of which is hereby incorporated herein by reference in its entirety.

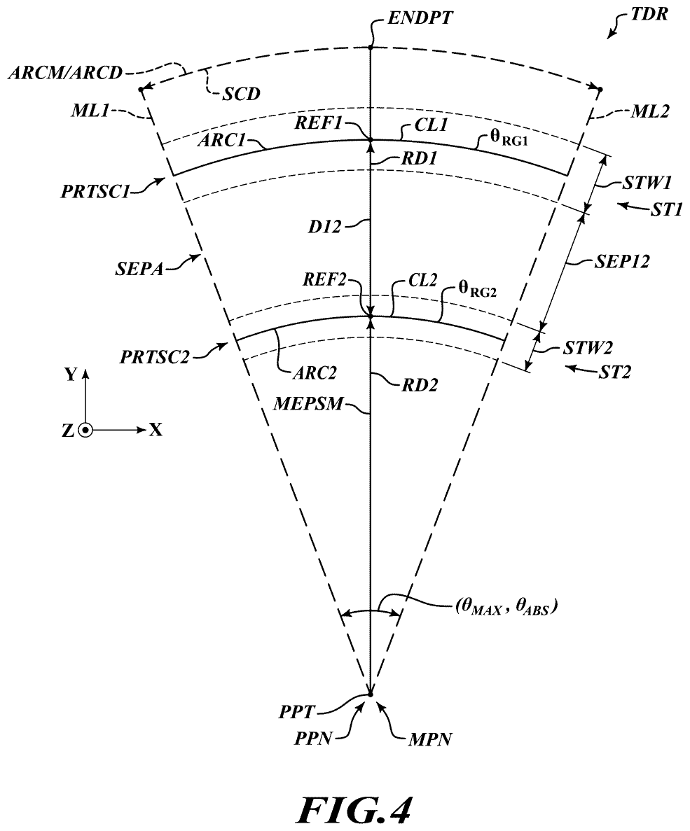

FIG. 4 is a diagram illustrating certain dimensions and aspects of the measuring instrument 100 including the transducer TDR. In FIG. 4, certain elements (e.g., the centerline CL1 of the first scale element portion PRTSC1, the centerline CL2 of the second scale element portion PRTSC2, the movable encoder portion support member MEPSM, etc.) are each represented as lines (e.g., for which the positions may correspond to those of central lines or other representations of the corresponding components). Representations of the pivot portion PPN including the pivot point PPT, as part of the moveable portion MPN, are illustrated (e.g., the contact portion CPN is not illustrated in FIG. 4, but will be understood to be located beneath the pivot portion PPN, such as illustrated in FIG. 2).

The moveable encoder portion support member MEPSM is illustrated as rotating around the pivot portion PPN in an arc motion direction. The support member MEPSM may move between first and second movement limit indicators ML1 and ML2, as part of moving over a maximum angular movement range θ_{MAX}. In certain implementations, the maximum angular movement range θ_{MAX} may correspond to the absolute angular measurement range θ_{ABS}. In various alternative implementations, the absolute angular measurement range θ_{ABS} and the maximum angular movement range θ_{MAX} may be different. As described above with respect to FIG. 2, an endpoint ENDPT corresponds to an end of the moveable encoder portion support member MEPSM, and also corresponds to an end of the moveable portion MPN, and correspondingly moves in the arc motion along the arc motion direction.

In some implementations, the first and second scale element portions PRTSC1 and PRTSC2 of the scale portion 170 may be attached to the moveable encoder portion support member MEPSM (e.g., in implementations where the moveable encoder portion MEP includes the scale portion 170) in which case the first and second scale element portions PRTSC1 and PRTSC2 will move in accordance with the arc motion ARCM along the arc motion direction ARCD, relative to the detector portion 167. Alternatively, if the moveable encoder portion MEP includes the detector portion 167, then the detector portion 167 may be attached to the moveable encoder portion support member MEPSM, and will correspondingly move in accordance with the arc motion ARCM in the arc motion direction ARCD, relative to the first and second scale element portions PRTSC1 and PRTSC2 of the scale portion 170.

As shown in FIGS. 3A and 4, the first scale element portion PRTSC1 and/or the first sensing element portion PRTSEN1 has a first central reference point REF1 (e.g., located at a central x and/or y-axis location, such as at a centerline CL1, of the first scale element portion PRTSC1 and/or of the first sensing element portion PRTSEN1), which is located at a first radial distance RD1 from the pivot portion PPN (e.g., from the pivot point PPT of the pivot portion PPN). The second scale element portion PRTSC2 and/or the second sensing element portion PRTSEN2 has a second central reference point REF2 (e.g., located at a central x and/or y-axis location, such as at a centerline CL2, of the second scale element portion PRTSC2 and/or of the second sensing element portion PRTSEN2) that is located at a second radial distance RD2 from the pivot portion PPN (e.g., from the pivot point PPT of the pivot portion PPN).

As illustrated in FIGS. 3A and 4, the first and second scale element portions PRTSC1 and PRTSC2 of the first and second track portions TR1 and TR2 are arc-shaped and are parallel to each other (e.g., form concentric arcs). The second track portion TR2 is closer to the pivot portion PPN than the first track portion TR1 (e.g., such that a radial distance RD2 of a second central reference point REF2 of the second track portion TR2 is smaller than a radial distance RD1 of a first central reference point REF1 of the first track portion TR1). As illustrated in FIG. 3A, the first signal modulating scale elements SME1 are disposed along the first scale element portion PRTSC1 according to a first signal modulating element angular spatial step θ_{WSME1} and the second signal modulating scale elements SME2 are disposed along the second scale element portion PRTSC2 according to a second signal modulating element angular spatial step θ_{WSME2} that is different than the first signal modulating element angular spatial step θ_{WSME1}. As will be described in more detail below, in certain implementations, at least one of the first or second signal modulating element angular spatial steps θ_{WSME1} or θ_{WSME2} does not divide evenly into 360 degrees.

As illustrated in FIG. 4, the first scale element portion PRTSC1 has a first angular range θ_{RG1} and a corresponding arc length ARC1, and the second scale element portion PRTSC2 has a second angular range θ_{RG2} and a corresponding arc length ARC2. The angular ranges θ_{RG1} and θ_{RG2} are indicated as being nominally equal, and in the example of FIGS. 3A and 4 are indicated as being nominally equal to the absolute angular measurement range θ_{ABS} and to the maximum angular movement range θ_{MAX}. As will be described in more detail below, the first and second signal modulating element angular spatial steps θ_{WSME1} and θ_{WSME2} may be related to the absolute angular measurement range θ_{ABS}. The arrangement of the first scale element portion PRTSC1 with the first angular range θ_{RG1} and arc length ARC1 and the second scale element portion PRTSC2 with the second angular range θ_{RG2} and arc length ARC2 enables operations which in combination achieve the absolute angular measurement range θ_{ABS}.

A scale direction SCD (e.g., which in the implementation of FIGS. 3A and 4 is in an arc direction) is indicated (e.g., along which the signal modulating elements SME of the first and second scale element portions PRTSC1 and PRTSC2 may be arranged, such as in accordance with the respective angular spatial steps θ_{WSME1} and θ_{WSME2}, such as illustrated in FIG. 3A). In various implementations, the first scale element portion PRTSC1 (e.g., which is arc-shaped) is arranged at the first radial distance RD1 from the pivot portion PPN and the second scale element portion PRTSC2 (e.g., which is arc-shaped) is arranged at the second radial distance RD2 from the pivot portion PPN, for which the first radial distance RD1 is larger than the second radial distance RD2. In various implementations, the first and second scale element portions PRTSC1 and PRTSC2 define a corresponding absolute angular measurement range θ_{ABS} (e.g., wherein each relative position between the detector portion 167 and the scale portion 170 within the absolute angular measurement range θ_{ABS} produces a unique combination of detector signals from the detector portion 167).

In various implementations, the ratio of the signal modulating element angular spatial steps θ_{WSME2}/θ_{WSME1} can be expressed in accordance with being equal to at least one of the following EQUATIONS 1-4, for which n and m are positive integers in each of the equations. In certain implementations, m is a positive integer that is at least 2 (e.g., for which in certain implementations m may be 2, 3, 4, or 5, etc.). It is noted that such relationships for a configuration in which m is 2 or larger corresponds to a relatively large difference between the signal modulating element angular spatial steps θ_{WSME1} and θ_{WSME2} (e.g., where the angular spatial step θ_{WSME2} is close to being an integer multiple (e.g., m=2 or larger) of the angular spatial step θ_{WSME1}). In implementations where m=1, the equations are noted to be reducible to a simpler form (e.g., in which the nm factor reduces to n). In relation to these equations, it is noted that one technique for encoding an absolute angular measurement range θ_{ABS} into an encoder utilizing arc motion is to use two scale element portions with signal modulating element angular spatial steps that satisfy certain relationships. For example, the following equations illustrate certain relationships that the signal modulating element angular spatial steps θ_{WSME1} and θ_{WSME2} of the scale element portions PRTSC1 and PRTSC2 of the track portions TR1 and TR2 may satisfy.

$${θ}_{WSME 2} / {θ}_{WSME 1} = ( n m / ( n - 1 ) ) \qquad ( Eq . 1 )$$

$${θ}_{WSME 2} / {θ}_{WSME 1} = ( n m / ( n + 1 ) ) \qquad ( Eq . 2 )$$

$${θ}_{WSME 2} / {θ}_{WSME 1} = ( ( n m + 1 ) / n ) \qquad ( Eq . 3 )$$

$${θ}_{WSME 2} / {θ}_{WSME 1} = ( ( n m - 1 ) / n ) \qquad ( Eq . 4 )$$

In various implementations, the absolute angular measurement range θ_{ABS} is equal to one of nθ_{WSME1} or nθ_{WSME2}. For example, in certain implementations, a configuration corresponding to EQUATION 1 or 2 may meet an additional condition where the absolute angular measurement range θ_{ABS}=nθ_{WSME1}, and a configuration corresponding to EQUATION 3 or 4 may meet an additional condition where the absolute angular measurement range θ_{ABS}=nθ_{WSME2}. In various implementations, a configuration corresponding to EQUATION 1 may meet an additional condition where the absolute angular measurement range θ_{ABS}=((n−1)/m)θ_{WSME2}, a configuration corresponding to EQUATION 2 may meet an additional condition where the absolute angular measurement range θ_{ABS}=((n+1)/m)θ_{WSME2}, a configuration corresponding to EQUATION 3 may meet an additional condition where the absolute angular measurement range θ_{ABS}=(nm+1)θ_{WSME1}, and a configuration corresponding to EQUATION 4 may meet an additional condition where the absolute angular measurement range θ_{ABS}=(nm−1)θ_{WSME1}. In accordance with such relationships, it will be appreciated that a method for choosing the two signal modulating element angular spatial steps is to set an integer number n of angular spatial steps (e.g., for either θ_{WSME1} or θ_{WSME2}) to be included in the absolute angular measurement range θ_{ABS}, and for which the other signal modulating element angular spatial step (e.g., either θ_{WSME2} or θ_{WSME1}) may be determined according to a relationship such as that indicated above.

In various implementations, the first scale element portion PRTSC1 has an arc length ARC1 and is arranged at a first radial distance RD1 from the pivot portion PPN, and the second scale element portion PRTSC2 has an arc length ARC2 and is arranged at a second radial distance RD2 from the pivot portion PPN (e.g., as indicated in FIG. 4), for which ARC2/ARC1=RD2/RD1. In various implementations, the second signal modulating element angular spatial step θ_{WSME2} is larger than first signal modulating element angular spatial step θ_{WSME1} (e.g., in configurations in which m is 2 or larger then the angular spatial step θ_{WSME2} may be close to being a corresponding integer multiple of the angular spatial step θ_{WSME1}).

As noted above, the first signal modulating element pattern PATSME1 in the first scale element portion PRTSC1 in the first track portion TR1 includes a first half pattern portion FHPP1 and a second half pattern portion SHPP1, with each half pattern portion including a row of first signal modulating elements SME1. In each scale row the first signal modulating elements SME1 are disposed (e.g., spaced/spatially positioned) according to a first signal modulating element angular spatial step θ_{WSME1}. For the two adjacent scale rows in the half pattern portions, the spatial phase of the scale row in the second half pattern portion is offset from the spatial phase of the adjacent scale row in the first half pattern portion by ½ of the first signal modulating element angular spatial step θ_{WSME1}. Thus, in this example, the signal modulating element spatial phase offset is ½ of the first signal modulating element angular spatial step θ_{WSME1} (e.g., which may correspond to a 180 degree spatial phase shift/difference between the adjacent scale rows).

As noted above, the second signal modulating element pattern PATSME2 in the second scale element portion PRTSC2 in the second track portion TR2 includes a first half pattern portion FHPP2 and a second half pattern portion SHPP2, with each half pattern portion including a row of second signal modulating elements SME2. In each scale row the second signal modulating elements SME2 are disposed (e.g., spaced/spatially positioned) according to a second signal modulating element angular spatial step θ_{WSME2}. For the two adjacent scale rows in the half pattern portions, the spatial phase of the scale row in the second half pattern portion is offset from the spatial phase of the adjacent scale row in the first half pattern portion by ½ of the second signal modulating element angular spatial step θ_{WSME2}. Thus, in this example, the signal modulating element spatial phase offset is ½ of the second signal modulating element angular spatial step θ_{WSME2} (e.g., which may correspond to a 180 degree spatial phase shift/difference between the adjacent scale rows).

In various implementations, in the first sensing element portion PRTSEN1, the first and second sets of first sensing elements SET1SEN1 and SET2SEN1 are at different angular spatial phase positions, as separated by a first sensing element angular spatial phase offset. In various implementations, a first sensing element angular spatial step θ_{WSEN1} of the first sensing element portion PRTSEN1 (e.g., of each of the sets of first sensing elements SET1SEN1 and SET2SEN1) may correspond to (e.g., be equal to) the first signal modulating element angular spatial step θ_{WSME1} of the first scale element portion PRTSC1. In various implementations, the first sensing element angular spatial phase offset may be equal to approximately ¼ of the first sensing element angular spatial step θ_{WSEN1} (e.g., in accordance with a quadrature configuration, as will be understood by one skilled in the art).

Similarly, in various implementations, in the second sensing element portion PRTSEN2, the first and second sets of second sensing elements SET1SEN2 and SET2SEN2 are at different angular spatial phase positions, as separated by a second sensing element angular spatial phase offset. In various implementations, a second sensing element angular spatial step θ_{WSEN2} of the second sensing element portion PRTSEN2 (e.g., of each of the sets of second sensing elements SET1SEN2 and SET2SEN2) may correspond to (e.g., be equal to) the second signal modulating element angular spatial step θ_{WSME2} of the second scale element portion PRTSC2. In various implementations, the second sensing element angular spatial phase offset may be equal to approximately ¼ of the second sensing element angular spatial step θ_{WSEN2} (e.g., in accordance with a quadrature configuration, as will be understood by one skilled in the art).

In one example implementation, θ_{WSME1}=0.0300 radians and θ_{WSME2}=0.625 radians. In relation to these values and in accordance with EQUATION 1, θ_{WSME2}/θ_{WSME1}=(nm/(n−1))=(50/24)=0.0625 radians/0.0300 radians=3.58 degrees/1.72 degrees. In addition, in various implementations θABS can be determined in accordance with θ_{ABS}=nθ_{WSME1}=25(0.0300 radians)=0.75 radians or 25(1.72 degrees)=43 degrees, and with θ_{ABS}=((n−1)/m)θ_{WSME2}=((25−1)/2)(0.0625 radians)=0.75 radians or ((25−1)/2)(3.58 degrees)=43 degrees. In accordance with these relationships, within the absolute angular measurement range θ_{ABS} there are 25 θ_{WSME1} (corresponding to 25 SME1) and 12 θ_{WSME2} (corresponding to 12 SME2). It is noted that the relationships of this configuration may alternatively be written in terms of EQUATION 3, where if n=12 and m=2, then θ_{WSME2}/θ_{WSME1}=((nm+1)/n)=25/12=0.0625 radians/0.0300 radians or 3.58 degrees/1.72 degrees. In addition, θ_{ABS}=Nθ_{WSME2}=12(0.0625 radians)=0.75 radians or 12(3.58 degrees)=43 degrees, and θ_{ABS}=(nm+1)θ_{WSME1}=(24+1)(0.0300 radians)=0.75 radians or (24+1) 1.72 degrees=43 degrees.

As another example, it is noted that in an alternative arrangement in which the absolute angular measurement range θ_{ABS} (remaining at 0.75 radians=43 degrees) included 25 θ_{WSME1} (corresponding to 25 SME1), where θ_{WSME1} remains at 0.0300 radians=1.72 degrees, and includes 13 θ_{WSME2} (corresponding to 13 SME2), with θ_{WSME2}=0.75 radians/13=0.0577 radians or 43 degrees/13=3.31 degrees, the relationships could be expressed in terms of EQUATIONS 2 or 4. More specifically, with n=25 and m=2, in accordance with EQUATION 2, θ_{WSME2}/θ_{WSME1}=(nm/(n+1))=50/26=0.0577 radians/0.0300 radians=3.31 degrees/1.72 degrees. With θ_{ABS}=nθ_{WSME1}=((n+1)/m)θ_{WSME2}, within the absolute angular measurement range there are 25 θ_{WSME1} (corresponding to 25 SME1) and 13 θ_{WSME2} (corresponding to 13 SME2). Alternatively, with n=13 and m=2, in accordance with EQUATION 4, θ_{WSME2}/θ_{WSME1}=((nm−1)/n)=25/13=0.0577 radians/0.0300 radians=3.31 degrees/1.72 degrees. With θ_{ABS}=nθ_{WSME2}=(nm−1)θ_{WSME1}, within the absolute angular measurement range there are 13 θ_{WSME2} (corresponding to 13 SME2) and 25 θ_{WSME1} (corresponding to 25 SME1). As yet another alternative example, with n=12 and m=2, in accordance with EQUATION 4, θ_{WSME2}/θ_{WSME1}=((nm−1)/n)=23/12=0.0625 radians/0.0326 radians=3.58 degrees/1.87 degrees. With θ_{ABS}=nθ_{WSME2}=(nm−1)θ_{WSME1}, within the absolute angular measurement range there are 12 θ_{WSME2} (corresponding to 12 SME2) and 23 θ_{WSME1} (corresponding to 23 SME1).

In the transducer of FIGS. 3A and 4, the first scale element portion PRTSC1 is within a first scale track ST1 having a first scale track width STW1 (e.g., for which the upper and lower edges of the first scale element portion PRTSC1 may correspond to the upper and lower boundaries of the first scale track ST1). The second scale element portion PRTSC2 is within a second scale track ST2 having a second scale track width STW2 (e.g., for which the upper and lower edges of the second scale element portion PRTSC2 may correspond to the upper and lower boundaries of the second scale track ST2). A separation distance SEP12 is illustrated as a radial distance between the first and second scale tracks ST1 and ST2. A separation area SEPA is illustrated between the first and second scale tracks ST1 and ST2 (e.g., having a radial width defined by the separation distance SEP12, and such as defined by the lower boundary of the first scale track ST1 and the upper boundary of the second scale track ST2). It is noted that the separation area SEPA is illustrated as being empty (e.g., as not including a scale element portion as arranged in an encoder track portion with a sensing element portion). A difference distance D12 is indicated as a difference in distance between the central reference points REF1 and REF2, and is correspondingly also a difference between the first radial distance RD1 and the second radial distance RD2. As some specific example dimensions, in one implementation the first scale track width STW1 may be 4.0 mm, the second scale track width STW2 may be 2.75 mm, the separation distance SEP12 may be 8.25 mm, the first radial distance RD1 may be 37.125 mm, the second radial distance may be 25.5 mm and the difference distance D12 may be 11.625 mm. In various implementations, such dimensions may result in certain desirable operating characteristics, as will be described in more detail below.

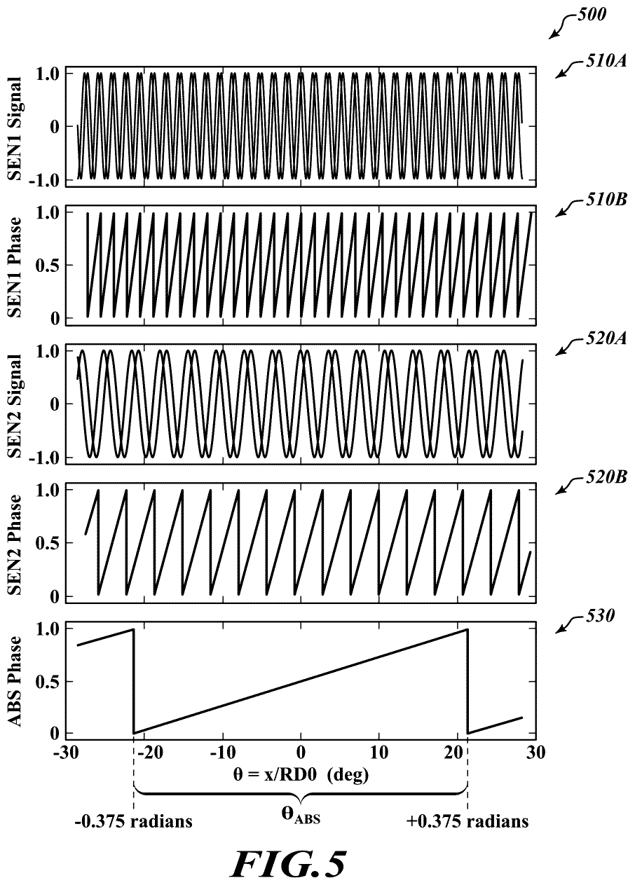

FIG. 5 is a diagram illustrating certain signals 500 resulting from the operation of the transducer TDR of FIG. 3A with arc motion between the detector portion 167 and the scale portion 170. As shown in FIG. 5, a graph 510A illustrates SEN1 signals as a function of angular position. In various implementations, the signals of the graph 510A may correspond to the detector signals SIG1A and SIG1B of the transducer portion PRTTDR1 of the first track portion TR1. A graph 520A similarly illustrates SEN2 signals as a function of angular position. In various implementations, the signals of the graph 520A may correspond to the detector signals SIG2A and SIG2B of the transducer portion PRTTDR2 of the second track portion TR2. Graphs 510B and 520B illustrate phase signals for the SEN1 and SEN2 signals of the graphs 510A and 520A, respectively (e.g., from calculating the arctan (SIG×B/SIG×A), such as arctan (SIG1B/SIG1A) and arctan (SIG2B/SIG2A)).

The graph 530 illustrates an absolute ABS phase signal (e.g., as resulting from a combining of the other signals, such as including those of the graphs 510B and 520B). In various implementations, the absolute ABS phase signal may be represented according to:

$${Φ}_{ABS} = {Φ}_{SIG 1} - m {Φ}_{SIG 2} \qquad ( Eq . 5 )$$

As indicated in the graph 530, the absolute angular measurement range GABS extends over a range from −21.5 degrees to +21.5 degrees (i.e., from −0.375 radians to +0.375 radians), as corresponding to an absolute angular range of 43 degrees (i.e., 0.75 radians). Correspondingly, in the graphs 510A and 510B, there are 25 cycles/periods (e.g., corresponding to 25 SME1's in the first scale element portion PRTSC1 of the first track portion TR1) illustrated within the −21.5 degrees to +21.5 degrees (i.e., −0.375 radians to +0.375 radians) angular range, and in the graphs 520A and 520B, there are 12 cycles/periods (e.g., corresponding to 12 SME2's in the second scale element portion PRTSC2 of the second track portion TR2) illustrated within the −21.5 degrees to +21.5 degrees (i.e., −0.375 radians to +0.375 radians) angular range.

It will be appreciated that in accordance with the principles as described herein, an absolute angular measurement range θ_{ABS} may be tailored/configured for a particular maximum angular movement range θ_{MAX} for a particular application. The above specific numerical examples illustrate an arrangement configured for an absolute angular measurement range θ_{ABS} of 43 degrees (i.e., 0.75 radians), although it will be appreciated that other arrangements may be configured for larger or smaller absolute angular measurement ranges in accordance with principles as described above. In some implementations, smaller absolute angular measurement ranges may be utilized for particular applications (e.g., ranges smaller than 15 degrees, or 10 degrees, or 5 degrees).

It will be appreciated that the ability to tailor the absolute angular measurement range GABS for a particular application may have certain advantages. For example, for a multi-track transducer, a design for a longer absolute angular measurement range generally requires a certain level of resolution and precision in order to be able to achieve the longer range (e.g., with appropriate and distinct signal levels over the full range, such as with a high level of information accuracy required for each increment, in particular in regard to the relationships between the multiple track portions (e.g., TR1 and TR2), in order for each increment to be distinguishable over the full range). In contrast, for a relatively shorter absolute angular measurement range in a multi-track transducer (e.g., such as may be formed in accordance with principles as described herein), a higher level of resolution may be achieved over the smaller range (e.g., utilizing smaller and/or otherwise different increments/spatial steps between the multiple tracks that could otherwise be too fine and/or have other issues for a longer range) and/or sufficient accuracy may be achieved over the smaller range utilizing an implementation with lower complexity/cost/power requirements, etc.

In some implementations, a comparison may be made to absolute rotary encoders which have an integer number of angular spatial steps in each track portion around a full 360 degree absolute range (e.g., in order to function effectively for continually measuring angular position in implementations where full 360 degree rotations and beyond may be performed). In accordance with such principles, if a portion of such a rotary encoder is utilized in an arc motion application (e.g., if ¼ or ⅛ of such a rotary encoder is utilized for a measurement range of 90 degrees, or 45 degrees), the angular spatial steps in each track portion will still correspondingly divide evenly into 360 degrees. For example, if a portion of such a rotary encoder is being utilized, for each track portion in the transducer, 360 degrees divided by the given angular spatial step of the track portion will equal an integer number.

Such implementations utilizing a portion of a rotary encoder are noted to have certain drawbacks (e.g., as noted above, a design for a relatively longer measurement range such as the full 360 degree angular measurement range generally requires a certain level of resolution and precision in order to be able to achieve the full 360 degree range, in particular in regard to the relationships between the track portions, in order for each increment to be distinguishable). In contrast, as noted above, an arc motion encoder may be formed in accordance with principles as described herein with a relatively smaller absolute angular measurement range (i.e., that is less than 360 degrees, and in some implementations may be smaller such as less than 45 degrees, or 15 degrees, or 5 degrees), and which has certain advantages such as those noted above.

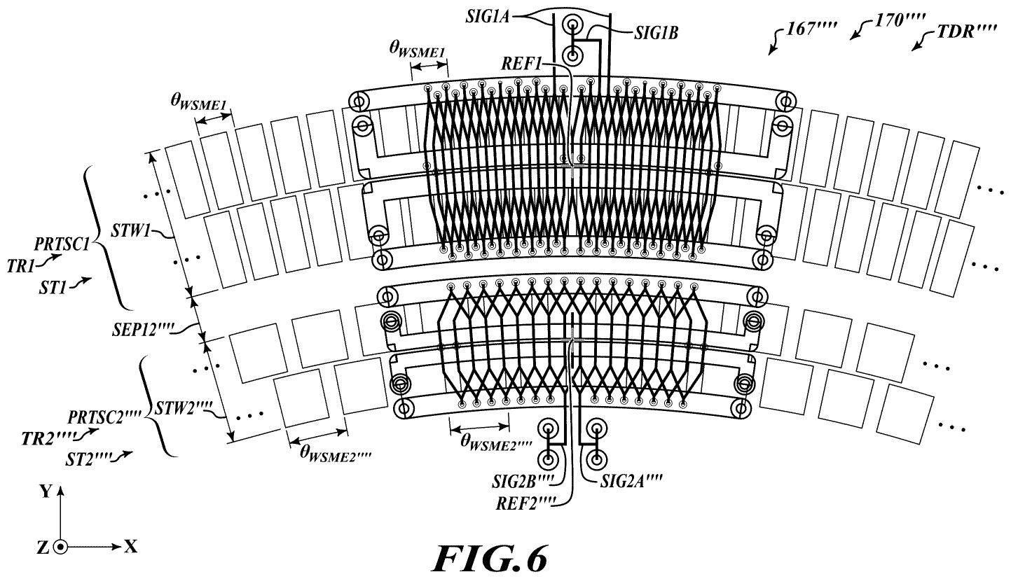

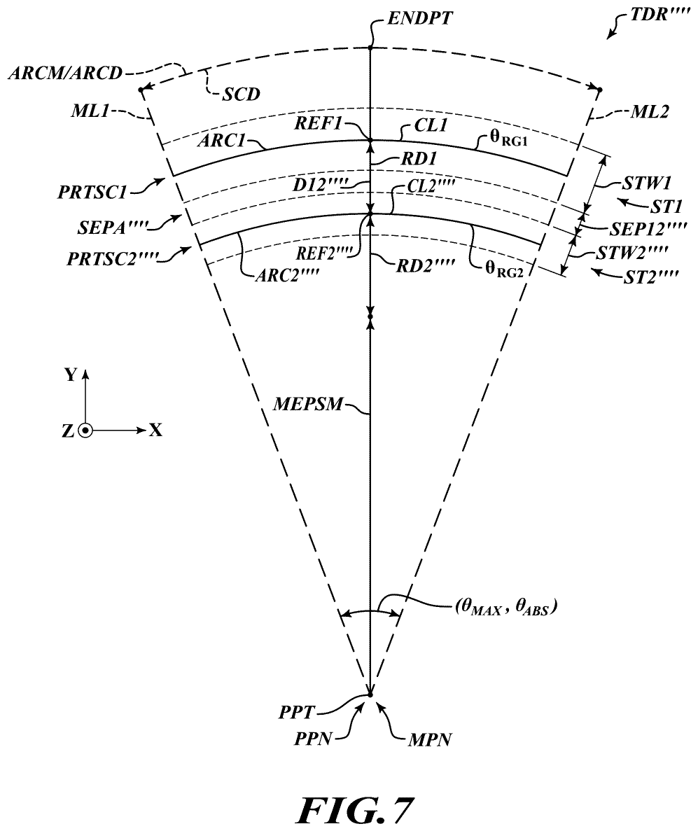

FIG. 6 is a diagram of an implementation of a portion of a transducer TDR″″ configured to be utilized with arc motion between a detector portion 167″″ and a scale portion 170″″ such as may be utilized in the measuring instrument of FIG. 2 and having a relatively smaller separation of the scale tracks ST1 and ST2″″ in comparison to the implementation of FIG. 3A. FIG. 7 is a diagram illustrating certain dimensions and features of the measuring instrument of FIG. 2 and the transducer of FIG. 6. The implementation of FIGS. 6 and 7 is noted to be similar to the implementation of FIGS. 3A and 4 in certain respects, as will be described in more detail below.

It is noted that the first encoder track portion TR1 in the implementation of FIGS. 6 and 7 is identical to the first encoder track portion TR1 of the implementation of FIGS. 3A and 4, and will be understood based on the above description of the first encoder track portion TR1. The second encoder track portion TR2″″ of FIGS. 6 and 7 is configured to produce similar signals as the second encoder track portion TR2 of FIGS. 3A and 4, and for which FIG. 5 is representative of signals resulting from the operation of the implementation of FIGS. 6 and 7, as well as being representative of signals resulting from the operation of the implementation of FIGS. 3A and 4. In this regard, during operations, the signals SIG2A″″ and SIG2B″″ of the implementation of FIG. 6 may be similar to the signals SIG2A and SIG2B of the implementation of FIG. 3A.

Also, each of the components of the second encoder track portion TR2 of FIG. 3A will be understood to have a corresponding component in the second encoder track portion TR2″″ of FIG. 6 (e.g., as may be designated with a quadruple prime ″″). As such, the components of the transducer TDR″″ will be understood by one skilled in the art based on the corresponding components of the transducer TDR, except as otherwise described below. As such, a complete description of the components of the transducer TDR″″ will not be provided herein, although for reference a brief description will be provided below. This numbering scheme (e.g., including utilization of different numbers of prime designations, such as XX, XX′, XX″, etc.) to indicate elements having analogous design and/or function is also applied to the other figures as described herein.

In general, the components in the second encoder track portion TR2″″ of FIG. 6 may be larger along the arc motion direction ARCD than the corresponding components of the second encoder track portion TR2 of FIG. 3A. In various implementations, the larger sizes of the components are in accordance with the larger radial distance RD2″″ as compared to the radial distance RD2, and the corresponding larger arc length ARC2″″ as compared to the arc length ARC2, as required for producing similar signals, as will be understood by one skilled in the art. In order to produce the similar signals, it is noted that the second signal modulating element angular spatial step θ_{WSME2}″″ of the second scale element portion PRTSC2″″ may be identical to the second signal modulating element angular spatial step θ_{WSME2} of the second scale element portion PRTSC2, and that the second sensing element angular spatial step θ_{WSEN2}″″ may be identical to the second sensing element angular spatial step θ_{WSEN2}.

Similar to the implementation of FIGS. 3A and 4, in the implementation of FIGS. 6 and 7, the first scale element portion PRTSC1 is within a first scale track ST1 having a first scale track width STW1 (e.g., for which the upper and lower edges of the first scale element portion PRTSC1 may correspond to the upper and lower boundaries of the first scale track ST1). The second scale element portion PRTSC2″″ is within a second scale track ST2″″ having a second scale track width STW2″″ (e.g., for which the upper and lower edges of the second scale element portion PRTSC2″″ may correspond to the upper and lower boundaries of the second scale track ST2″″). A separation distance SEP12″″ is illustrated as a radial distance between the first and second scale tracks ST1 and ST2″″. A separation area SEPA″″ is illustrated between the first and second scale tracks ST1 and ST2″″ (e.g., having a radial width defined by the separation distance SEP12″″, and such as defined by the lower boundary of the first scale track ST1 and the upper boundary of the second scale track ST2″″). It is noted that the separation area SEPA″″ is empty (e.g., as not including a scale element portion as arranged in an encoder track portion with a sensing element portion).

As illustrated in FIG. 7, the first and second scale element portions PRTSC1 and PRTSC2″″ of the first and second track portions TR1 and TR2″″ are arc-shaped and are parallel to each other (e.g., form concentric arcs). The second track portion TR2″″ is closer to the pivot portion PPN than the first track portion TR1 (e.g., such that a radial distance RD2″″ of a second central reference point REF2″″ of the second track portion TR2″″ is smaller than a radial distance RD1 of a first central reference point REF1 of the first track portion TR1). In various implementations, the reference point REF1 may be at the centerline CL1 and the reference point REF2″″ may be at the centerline CL2″″. A difference distance D12″″ is indicated as a difference in distance between the central reference points REF1 and REF2″″, and is correspondingly also a difference between the first radial distance RD1 and the second radial distance RD2″″.

The first scale element portion PRTSC1 has a first angular range θ_{RG1} and a corresponding arc length ARC1, and the second scale element portion PRTSC2″″ has a second angular range θ_{RG2} and a corresponding arc length ARC2″″. The angular ranges θ_{RG1} and θ_{RG2} are indicated as being nominally equal, and in the example of FIGS. 6 and 7 are indicated as being nominally equal to the absolute angular measurement range θ_{ABS} and to the maximum angular movement range θ_{MAX}.

As some specific example dimensions, in one implementation the first scale track width STW1 may be 4.0 mm, the second scale track width STW2 may be 2.75 mm, the separation distance SEP12 may be 1.25 mm, the first radial distance RD1 may be 37.125 mm, the second radial distance RD2 may be 32.5 mm and the difference distance D12 may be 4.625 mm. In various implementations, such dimensions may result in certain less desirable operating characteristics (e.g., such as compared to those of the implementation of FIGS. 3A and 4), as will be described in more detail below.

It is noted that the implementation of FIGS. 6 and 7 results in a smaller overall size of the corresponding transducer TDR″″, as compared to the implementation of FIGS. 3A and 4 with the relatively larger overall size of the corresponding transducer TDR. This is a primary reason why prior art encoders have typically been designed with a relatively small spacing between the encoder tracks, in order to limit the corresponding overall size. In accordance with such prior art design principles, it may have been considered counterintuitive and/or surprising that an implementation such as that of FIGS. 3A and 4 (i.e., with the relatively larger separation of the encoder/scale tracks) would result in certain more desirable operating characteristics, as will be described in more detail below.

In general, it is noted that for transducers utilizing arc motion, the signal periodicity depends on the spatial steps in the scale track portions and also on the radial distance of the scale portion and/or detector portion from the pivot portion. This may be contrasted with standard transducers utilizing only linear motion, where the signal periodicity depends only on the spatial steps in the scale track portions. The dependence of arc motion transducers on the radial distance of the scale portion and/or detector portion from the pivot portion may result in certain issues if there is an offset/misalignment. For example, a transducer may be designed to ideally operate with the scale portion and the detector portion centered and aligned relative to one another along a radial direction, which may result in a designed signal periodicity. However, if there is a radial offset/misalignment (e.g., of the scale portion relative to the detector portion), due to the dependency on the radial distance, the signal periodicity may be different from the design, as may result in positions determined by the operation of the transducer having a linear error (e.g., for which the error may increase linearly with further arc motion of the transducer as the measured position moves farther from a reference point).

As one example of how a radial offset/misalignment may occur, during manufacturing/assembly of a measuring instrument such as that of FIG. 2, the movable encoder portion MEP (e.g., consisting of a printed circuit board with the scale portion or the detector portion fabricated thereon) may be coupled (e.g., attached, affixed, etc.) to the support member MEPSM. During such manufacturing/assembly, some amount of radial offset/misalignment of the movable encoder portion MEP may occur (e.g., due to manufacturing tolerances, etc., such as for the positioning of the movable encoder portion MEP on the support member MEPSM). The resulting radial offset/misalignment of the movable encoder portion MEP (i.e., as coupled to the support member MEPSM) may correspond to a radial offset/misalignment of the scale portion (e.g., relative to the detector portion). As noted above, such a radial offset/misalignment may result in errors in a determined position of the transducer. As will be described in more detail below, in order to address such issues, in accordance with principles as described herein, an offset value that corresponds to such a radial offset may be determined based at least in part on signals from the transducer, and the determined offset value may be utilized to correct one or more values that are utilized to determine a relative position between the detector portion and the scale portion.

In various implementations, following concepts may be related to the determining of an offset value based at least in part on signals from the transducer. In relation to the signals of FIG. 5, the SEN1 signal and the SEN1 phase (e.g., corresponding to signal phase Φ_{SIG1}) correspond to the first signal modulating element angular spatial step θ_{WSME1} of the first scale element portion PRTSC1 of the first scale track ST1. Similarly, the SEN2 signal and the SEN2 phase (e.g., corresponding to signal phase Φ_{SIG2}) correspond to the second signal modulating element angular spatial step θ_{WSME2} of the second scale element portion PRTSC2 of the second scale track ST2. As described above, the first signal modulating element angular spatial step Φ_{WSME1} is smaller than the second signal modulating element angular spatial step θ_{WSME2}, and for which the first signal modulating element angular spatial step θ_{WSME1} may be characterized as a finer or fine spatial step (e.g., of the fine track ST1), while the second signal modulating element angular spatial step θ_{WSME2}, may be characterized as a coarser spatial step (e.g., of the sub-track ST2).

As illustrated and described, the spatial step of the first scale element portion PRTSC1 of the first scale track ST1 may provide the finest measurement resolution, and so may be referenced and utilized as part of determining a highly accurate absolute measurement position. However, as part of determining an overall absolute measurement position, a determination must be made of which cycle/period of the SEN1 phase (i.e., corresponding to the signal phase Φ_{SIG1}) a current absolute measurement position is within or otherwise corresponds to (e.g., as may correspond to an integer number of spatial steps as occurring and for which the position indicated by the SEN1 phase/signal phase Φ_{SIG1} may then be added to). For example, in the illustration of FIG. 5, there are 25 periods/cycles of the SEN1 phase (i.e., corresponding to the signal phase Φ_{SIG1}), as corresponding to the 25 signal modulating elements SME1 (in the first scale element portion PRTSC1 of the first track portion TR1 of FIG. 6) and corresponding 25 spatial steps within the absolute range (i.e., within the absolute range θ_{ABS} as indicated for the absolute ABS phase). It is also noted that there are 12 periods/cycles of the SEN2 phase (i.e., corresponding to the signal phase Φ_{SIG2}), as corresponding to the 12 signal modulating elements SME2 and corresponding 12 spatial steps within the absolute range. In further regard to FIG. 5, in various implementations the absolute ABS phase (i.e., corresponding to the signal phase Φ_{ABS}) may have sufficient accuracy for being utilized to determine which cycle/period a current absolute measurement position corresponds to. In various implementations, such a process may be referenced as a phase unwrapping process, or a chaindown process, etc.

In certain implementations, the absolute ABS phase (i.e., corresponding to the signal phase Φ_{ABS}) may be considered to be sufficiently accurate for being utilized to determine which cycle/period (e.g., of the 25 cycle/periods in the example of FIG. 5) of the SEN1 phase (i.e., corresponding to the signal phase Φ_{SIG1}) a current absolute measurement position corresponds to. Such a corresponding process may be referenced as a direct chaindown process (i.e., for which only a single chaindown step is performed). Alternatively, as part of a more robust process (e.g., as more robust to certain types of encoder errors or other accuracy issues), the absolute ABS phase (i.e., corresponding to the signal phase Φ_{ABS}) may first be utilized to determine which cycle/period (e.g., of the 12 cycle/periods in the example of FIG. 5) of the SEN2 phase (i.e., corresponding to the signal phase Φ_{SIG2}) a current absolute measurement position corresponds to, and for which the results of such a first determination may then be utilized to determine which cycle/period (e.g., of the 25 cycle/periods in the example of FIG. 5) of the SEN1 phase (i.e., corresponding to the signal phase SIG1) a current absolute measurement position corresponds to. Such a corresponding process may be referenced as a double chaindown process (i.e., for which the two chaindown steps are performed).

As part of such chaindown processes, a rounding process may be performed (e.g., in relation to the absolute ABS phase/signal phase Φ_{ABS}, such in the direct chaindown process or in the first step of the double chaindown process). The amounts that are rounded away (e.g., between −0.5 and +0.5) may be referenced as chaindown values, and may represent a difference in the accumulated position values. In a perfect configuration (e.g., with no radial offset, etc.) chaindown values may be close to or at zero. However, in actual practical configurations (e.g., as manufactured and assembled, with certain manufacturing/assembly tolerances, etc.) there may be some amount of radial offset (e.g., as may result in certain chaindown values). As will be described in more detail below, in various implementations a chaindown slope (i.e., as corresponding to a chaindown curve plot of the chaindown values) may be determined and may be related to and/or utilized to determine an offset value (e.g., as corresponding to a radial offset of the scale portion, such as in relation to the detector portion, or as corresponding to a radial offset of the detector portion, such as in relation to the scale portion). In various implementations, the determined offset value may be utilized to correct one or more values (e.g., of a spatial step or other spatial dimension) that are utilized to determine a relative position between the detector portion and the scale portion.

As part of the chaindown processes described below, the absolute phase Φ_{ABS} is in the range [0, 1], and the signal phases Φ_{SIG1} and Φ_{SIG2} are in the range of [−0.5, +0.5], and may be expressed according to:

$${Φ}_{SIG 1} = ( 1 / 2 π ) arctan ( SIG 1 B / SIG 1 A ) \qquad ( Eq . 6 )$$

$${Φ}_{SIG 2} = ( 1 / 2 π ) arctan ( SIG 2 B / SIG 2 A ) \qquad ( Eq . 7 )$$

A relationship for the absolute phase Φ_{ABS} may be expressed according to:

$${Φ}_{ABS} = ( {Φ}_{SIG 1} - m {Φ}_{SIG 2} + {Φ}_{0} ) \% 1 \qquad ( Eq . 8 )$$

where Φ₀ is a buffer ABS signal phase that is included in some implementations to avoid a jump in the ABS spatial range/step, and %1 indicates a modulo/modulus operation, which returns the remainder or signed remainder of a division, after the number is divided by the designated divisor, which in this case the designated divisor is 1, and so the result is generally a non-integer value (e.g., the operation as performed would return 0.2 for a value of 1.2, etc.).

For a direct chaindown process, a next determination may be according to:

$${n}_{AWSME 1} = round ( ( {ϕ}_{ABS} ( {θ}_{ABS} / {θ}_{WSME 1} ) - {ϕ}_{SIG 1} + {ϕ}_{1} ) \qquad ( Eq . 9 )$$

where n_{AWSME1} is an integer number of first signal modulating element spatial steps for the absolute measurement distance determination, “round” indicates a rounding operation (e.g., for determining an integer number for n_{AWSME1}), and Φ₁ is included in some implementations to minimize 1st chaindown values to avoid a θ_{WSME1} spatial step jump. It is noted that θ_{ABS}/θ_{WSME1} yields the number of first signal modulating element angular spatial steps θ_{WSME1} in the absolute angular measurement range θ_{ABS} (e.g., in an example such as that described above where θ_{ABS}=0.75 radians and θ_{WSME1}=0.03 radians, then θ_{ABS}/θ_{WSME1}=25). After an integer number of first signal modulating element spatial steps n_{AWSME1} is determined according to EQUATION 9, the absolute measurement may be determined according to EQUATION 12, as will be described in more detail below.

As an alternative to the direct chaindown process, for a double chaindown process, as part of a first chaindown step a next determination after EQUATION 8 may be according to:

$${n}_{AWSME 2} = round ( ( {ϕ}_{ABS} ( {θ}_{ABS} / {θ}_{WSME 2} ) - {ϕ}_{SIG 2} + {ϕ}_{1} ) \qquad ( Eq . 10 )$$

where n_{AWSME2} is an integer number of second signal modulating element spatial steps for the absolute measurement distance determination, “round” indicates a rounding operation (e.g., for determining an integer number for n_{AWSME2}), and Φ₁ is included in some implementations to minimize 1st chaindown values to avoid a θ_{WSME2} spatial step jump. It is noted that θ_{ABS}/θ_{WSME2} yields the number of second signal modulating element angular spatial steps θ_{WSME2} in the absolute angular measurement range θ_{ABS} (e.g., in an example such as that described above where θ_{ABS}=0.75 radians and θ_{WSME2}=0.0625 radians, then θ_{ABS}/θ_{WSME2}=12). As further part of the double chaindown process, a second/next chaindown step may be according to:

$${n}_{AWSME 1} = round ( ( {n}_{AWSME 2} + {ϕ}_{SIG 2} ) ( {θ}_{WSME 2} / {θ}_{WSME 1} ) ) - {ϕ}_{SIG 1} + {ϕ}_{2} ) \qquad ( Eq . 11 )$$

where n_{AWSME1} is an integer number of first signal modulating element spatial steps for the absolute measurement distance determination, “round” indicates a rounding operation (e.g., for determining an integer number for n_{AWSME1}), Φ₂ is included in some implementations to minimize 2nd chaindown values to avoid a θ_{WSME1} spatial step jump, and θ_{WSME2}/θ_{WSME1} is a ratio value (e.g., with the above example values corresponding to 0.0625/0.03=2.0833).

After an integer number of first signal modulating element spatial steps n_{AWSME1} is determined according to EQUATION 9 (e.g., as part of a direct chaindown process) or according to EQUATION 11 (e.g., as part of a double chaindown process), the absolute measurement may be determined according to:

$${MEAS}_{ANG} = {θ}_{WSME 1} ( {n}_{AWSME 1} + {ϕ}_{SIG 1} ) - {θ}_{0} \qquad ( Eq . 12 )$$

where MEAS_{ANG} is the absolute angular measurement (e.g., in radians) and Oo is the angular origin position. In certain implementations, the absolute measurement may be expressed in terms of an arc distance, which in relation to the first signal modulating element angular spatial steps θ_{WSME1} and the radial distance RD1 of the first scale element portion PRTSC1 of the first scale track ST1 may be represented as:

$${MEAS}_{ARC} = ( {MEAS}_{ANG} ) RD 1 \qquad ( Eq . 13 )$$

This is noted to correspond to an arc distance along the first scale track ST1. As described above, the amounts that are rounded away (e.g., in either the direct or double chaindown process) may be referenced as chaindown values. In relation to the direct chaindown process and EQUATION 9, the chaindown values may be expressed according to:

$$chaindown value = ( {ϕ}_{ABS} ( {θ}_{ABS} / {θ}_{WSME 1} ) - {ϕ}_{SIG 1} + {ϕ}_{1} ) - {n}_{AWSME 1} \qquad ( Eq . 14 )$$

In relation to the double chaindown process and EQUATION 10, the chaindown values may be expressed according to:

$$chaindown value = ( {ϕ}_{ABS} ( {θ}_{ABS} / {θ}_{WSME 2} ) - {ϕ}_{SIG 2} + {ϕ}_{1} ) - {n}_{AWSME 2} \qquad ( Eq . 15 )$$

In various implementations, such chaindown values may be included in a chaindown plot and/or otherwise utilized to determine a chaindown slope, which can be utilized to correct a linear error, as will be described in more detail below. Briefly, in relation to EQUATION 12 (and certain other of the equations above) it is noted that if (e.g., due to a radial offset of the scale portion or the detector portion) the signal periodicity of the first scale element portion PRTSC1 of the first scale track ST1 does not match θ_{WSME1} (e.g., or the arc distance equivalent thereof), then the determined measurement accumulates error. A determined chaindown slope may be utilized to determine an offset value that corresponds to a radial offset of the scale portion or the detector portion (e.g., such as in relation to each other), for which the determined offset value may be utilized to correct a value (e.g., determining a corrected value θ_{WSME1C}) that can be utilized for the determining of the relative position between the detector portion and the scale portion (e.g., such as utilized in EQUATION 12).

Stated more generally, transducers utilizing arc motion are generally sensitive to radial offset/misalignment (e.g., of the scale portion in relation to the sensing portion), for which such radial offset/misalignment causes a linear long-range-error (LRE) (e.g., with a slope in some implementations approximately equal to the radial offset divided by the radial distance of the scale track). One method for correcting such an LRE would be to calibrate against a known standard (e.g., such as a reference encoder or gage blocks), although in some implementations such processes may be prohibitively complex, difficult, expensive, etc. As an alternative, and in accordance with certain principles as described herein, a two-track arc encoder (i.e., with a transducer utilizing arc motion) can be configured to “self-correct” such issues (e.g., at least in part by essentially utilizing the known separation of the first and second scale tracks as a reference and/or otherwise for correcting values). Stated another way, in implementations such as those described herein, wherein the first and second scale track portions have different radial distances from the pivot portion, then when a radial offset is present it causes a slope in the chaindown plot of the chaindown values (i.e., a chaindown slope) that can be measured (e.g., without the need for an external reference standard) and used to correct values (e.g., for correcting the linear error). As will be described in more detail below, in various implementations, a relatively large spacing/difference in the radial distances of the two scale tracks may enable a more/sufficiently accurate determination of an offset value (e.g., corresponding to the radial offset) that can be utilized to correct values (e.g., for correcting the linear error).

In accordance with the above noted principles, the following equations indicate certain corresponding relationships.

$$LRE slope = OFF / ( RD - OFF ) \approx OFF / RD \qquad ( Eq . 17 )$$

for which OFF is the radial offset and RD is the radial distance of the corresponding scale track/scale element portion. It is noted that the radial offset OFF is typically sufficiently small relative to the radial distance RD that RD-OFF may be sufficiently approximated by RD. For a direct chaindown process, the chaindown slope may be characterized according to:

$${CD SLOPE}_{DIR} \approx OFF ( ( 1 / RD 2 ) - ( 1 / RD 1 ) ) ( n ) \qquad ( Eq . 17 )$$

where CDSLOPE_{DIR} is the chaindown slope for the direct chaindown process, and RD1 and RD2 are the radial distances of the first and second scale element portions and correspondingly of the first and second scale tracks, respectively. In certain implementations, EQUATION 17 may be modified to be further specified according to:

$${CD SLOPE}_{DIR} \approx OFF ( ( 1 / RD 2 ) - ( 1 / RD 1 ) ) ( n - 1 ) \qquad ( Eq . 18 )$$

For a double chaindown process, the chaindown slope may be characterized according to:

$${CD SLOPE}_{DBL} \approx OFF ( ( 1 / RD 2 ) - ( 1 / RD 1 ) ) ( n / m ) \qquad ( Eq . 19 )$$

where CDSLOPE_{DBL} is the chaindown slope for the double chaindown process. It is noted that EQUATION 19 may be utilized to solve for the offset according to: −OFF≈CDSLOPE_{DBL}/(((1/RD2)−(1/RD1))(n/m)). In certain implementations, EQUATION 19 may be modified to be further specified according to:

$${CD SLOPE}_{DBL} \approx OFF ( ( 1 / RD 2 ) - ( 1 / RD 1 ) ) ( ( n - 1 ) / m ) \qquad ( Eq . 20 )$$

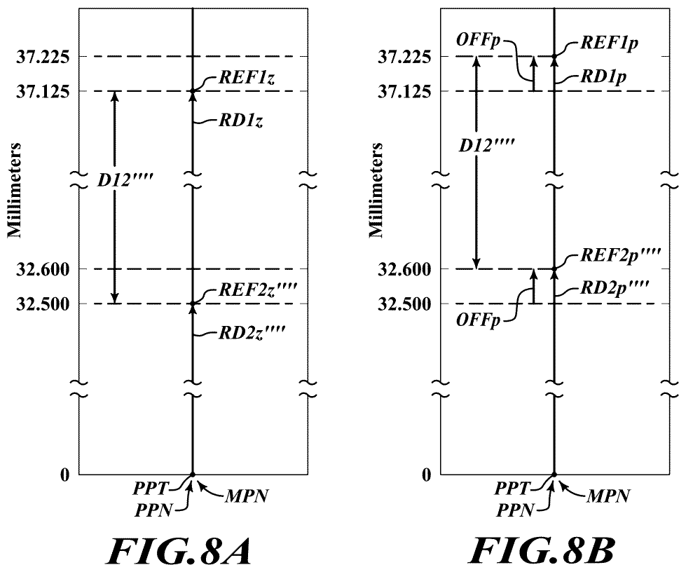

It is noted that EQUATION 20 may be utilized to solve for the offset according to: −OFF≈CDSLOPE_{DBL}/(((1/RD2)−(1/RD1))((n−1)/m)). In various implementations, a self-correction/correction process may be characterized according to:

$${θ}_{WSME 1 C} = {θ}_{WSME 1} ( 1 - ( {OFF}_{D} / RD 1 ) ) \qquad ( Eq . 21 )$$

where θ_{WSME1C} is the corrected value for θ_{WSME1} and OFF_{D} is the determined radial offset (e.g., as determined based on the chaindown slope CDSLOPE). The above noted principles and certain related examples (e.g., in relation to the above noted equations, etc.) will be described in more detail below with respect to FIGS. 8A-21.

FIGS. 8A-8B are diagrams illustrating an offset (e.g., a radial offset of the scale portion or the detector portion) in relation to certain features of FIGS. 6 and 7. FIG. 8A may be compared to and generally corresponds to a representation of portions of the vertical centerline of FIG. 7. In the illustration of FIG. 8A (e.g., which in various implementations may correspond to a condition of zero radial offset), the first central reference point REF1_{Z} (e.g., located at a central x and/or y-axis location, such as at a centerline CL1, of the first scale element portion PRTSC1 of the first scale track ST1 and/or of the first sensing element portion PRTSEN1) is at a radial distance RD1_{Z} from the pivot portion PPN. The second central reference point REF2_{Z}″″ (e.g., located at a central x and/or y-axis location, such as at a centerline CL2″″, of the second scale element portion PRTSC2″″ of the second scale track ST2″″ and/or of the second sensing element portion PRTSEN2″″) is at a radial distance RD2_{Z}″″ from the pivot portion PPN.

A difference distance D12″″ is indicated as a difference in distance between the central reference points REF1_{Z} and REF2_{Z}″″, and is correspondingly also a difference between the first radial distance RD1_{Z} and the second radial distance RD2_{Z}″″. As some specific numerical examples, the illustrations in FIG. 8A indicate the first radial distance RD1_{Z} may be 37.125 mm, the second radial distance RD2_{Z}″″ may be 32.5 mm (e.g., as corresponding to a numerical example described above with respect to FIGS. 6 and 7), and for which correspondingly the difference distance D12″″ may be 4.625 mm. As noted above, in the illustration of FIG. 7, the numerical examples may further include that the first scale track width STW1 may be 4.0 mm, the second scale track width STW2″″ may be 2.75 mm and the separation distance SEP12″″ may be 1.25 mm.

FIG. 8B illustrates a condition with an offset OFF_{P} (e.g., a radial offset of the scale portion or the detector portion). In the illustration of FIG. 8B (e.g., which in various implementations may correspond to a condition of a positive radial offset OFF_{P}), a first central reference point REF1_{P} (e.g., of the first scale element portion PRTSC1 of the first scale track ST1) has been shifted upward by the offset OFF_{P} so as to be at a radial distance RD1_{P} from the pivot portion PPN. The second central reference point REF2_{P}″″ (e.g., of the second scale element portion PRTSC2″″ of the second scale track ST2″″) has correspondingly also been shifted upward by the offset OFF_{P} (e.g., due to the first and second scale element portions and corresponding scale tracks being fabricated on a single PCB that may be coupled to the support member MEPSM of FIG. 2 such that the scale portion as a whole may have a radial offset OFF_{P}) so as to be at a radial distance RD2_{P}″″ from the pivot portion PPN. It is noted that the difference distance D12″″ is indicated as being the same in FIG. 8B as it was in FIG. 8A (e.g., for which in certain implementations the constant known difference distance D12″″ and/or corresponding characteristics may be regarded as being utilized as an internal reference for performing self-correction as described herein).

It is also noted that while in this example the scale portion may have a radial offset as indicated, the detector portion including the sensing portion may remain with central reference points REF1_{Z} and REF2_{Z}″″ at positions such as indicated in FIG. 8A. Thus, the radial offset of the scale portion may in some implementations be referenced as being in relation to the detector portion including the sensing portion (e.g., and for which in some implementations the detector portion including the sensing portion may also or alternatively be referenced as having a radial offset in relation to the scale portion). In an alternative example, the described positions may be switched, with the scale portion remaining with the central reference points REF1_{Z} and REF2_{Z}″″ at positions such as indicated in FIG. 8A, and with the sensing portion with the central reference points REF1_{P} and REF2_{P}″″ at positions such as indicated in FIG. 8B (e.g., for which the sensing portion may be stated to have a radial offset in relation to the scale portion and/or the scale portion may be stated to have a radial offset in relation to the sensing portion). As some specific numerical examples, the illustrations in FIG. 8B indicate the first radial distance RD1_{P} may be 37.225 mm, the second radial distance RD2_{P}″″ may be 32.6 mm (e.g., as corresponding to the positive radial offset OFF_{P} which may be 0.1 mm). The constant difference distance D12″″ may continue to be 4.625 mm.

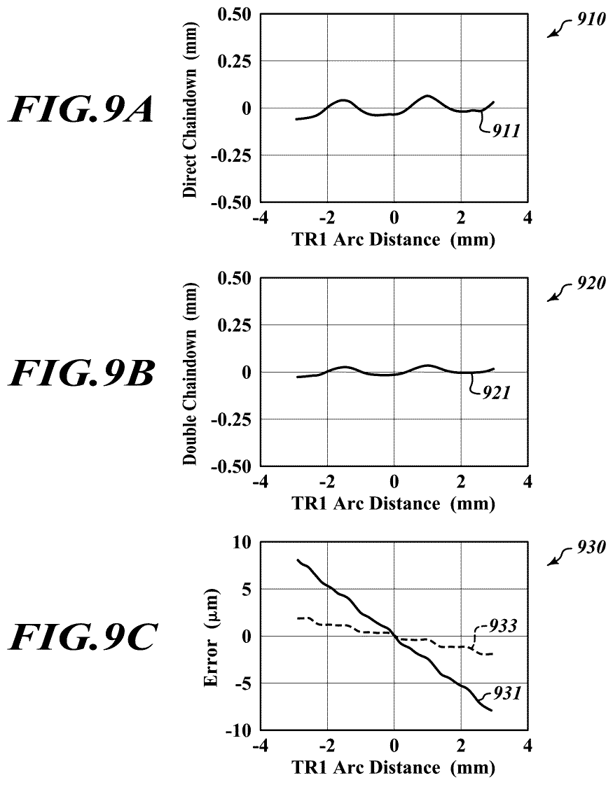

FIGS. 9A-9C are diagrams of graphs 910-930 illustrating certain data resulting from the operations and a correction process of the transducer of FIGS. 6 and 7 with an offset such as that illustrated in FIGS. 8A and 8B. The x-axis of the graphs 910-930 is in terms of arc distance along the first scale track TR1 (e.g., for which in various implementations EQUATION 13 or a similar calculation may be utilized for converting an angular value to an arc distance or vice versa, such as in accordance with known formulas for such calculations relating angular values to arc distances, etc.). In relation to the plotted graph values in millimeters in FIGS. 9A and 9C, in various implementations, an equation relating chaindown values in millimeters may be as follows:

$$chaindown ( in millimeters ) = chaindown * {θ}_{WSME 1} * RD 1 \qquad ( Eq . 22 )$$

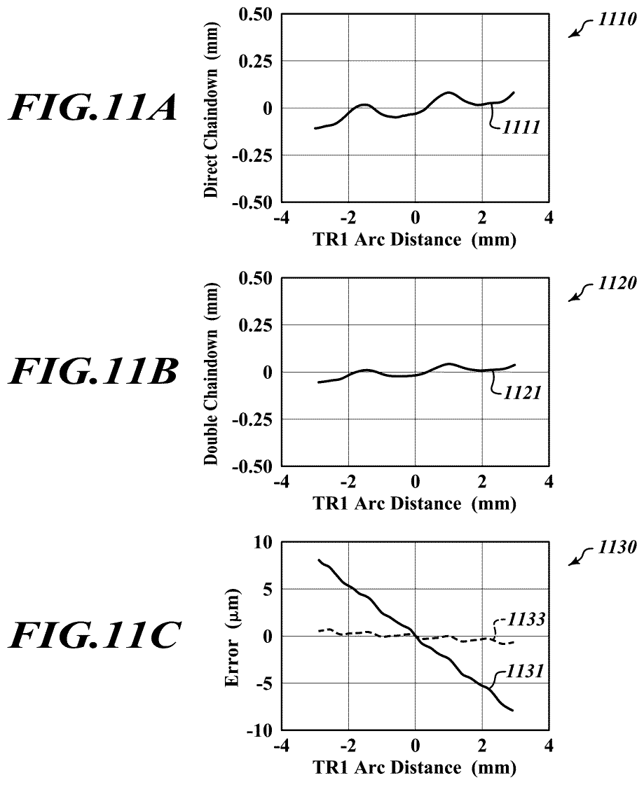

It is noted that the θ_{WSME1}*RD1 term is common to both axes and cancels in the slope calculation. This convention as applied to FIGS. 9A and 9B, is also applied to FIGS. 11A, 11B, 14A, 14B, 17A and 19A. In addition, it is noted that some or all of the plots/curve plots of FIGS. 9A-90, 11A-11C, 14A-14C, 17A-17B and 19A-19B and corresponding calculations described below may be according to a convention with −OFF, and that in an alternative convention with +OFF the plots/curve plots may be horizontally inverted and the signs of the calculated values may be reversed.

FIG. 9A is a graph 910 of a chaindown curve plot 911 of chaindown values for a direct chaindown process. FIG. 9B is a graph 920 of a chaindown curve plot 921 of chaindown values for a double chaindown process. It will be appreciated (e.g., as indicated by EQUATIONS 17-20) that the chaindown slope in FIG. 9B (i.e., for the double chaindown process) may be ½ of the chaindown slope in FIG. 9A (i.e., for the direct chaindown process), in accordance with the inclusion of the m variable (e.g., as equal to 2 in the current examples) in the denominator of the chaindown slope equations for the double chaindown process.

FIG. 9C is a graph 930 illustrating a long range error curve plots 931 and 933, where the long range error curve plot 931 represents data before a correction process, and long range error curve plot 933 represents data after a correction process has been performed according to principles as described herein (e.g., in accordance with EQUATION 21 and/or other processes). More specifically, in various implementations a chaindown slope may be determined based on data such as that indicated in either graph 910 or 920. As an example, in one specific implementation the determination of the chaindown slope may include applying a least-squares linear fit to the data.

The determined chaindown slope may be utilized to determine an offset value (e.g., that corresponds to a radial offset of the scale portion or the detector portion), such as in accordance with an equation (e.g., one of EQUATIONS 17-20) or other calculation or method that enables a determination of an offset value based on a determined chaindown slope or otherwise based on chaindown data. The determined offset value may be utilized to correct one or more values that are utilized to determine a relative position between the detector portion and the scale portion. For example, the determined offset value may be utilized in accordance with EQUATION 21 or other calculation for correcting a spatial step value or other spatial value of the scale portion, which may then be utilized in one or more equations (e.g., such as EQUATION 12) or other calculation for determining a measurement (i.e., which corresponds to a relative position between the detector portion and the scale portion).

As noted above, the long range error curve plot 933 represents data after such a correction process has been performed. The plot 933 with the correction (i.e., with a remaining slope of approximately −0.67 μm error per mm of measurement) indicates some improvement relative to the original error plot 931 (i.e., with a slope of approximately −2.67 μm error per mm of measurement). However, the remaining error (i.e., −0.67 μm per mm) may be too high for certain practical applications. In various implementations, this may be characterized as resulting at least in part from the difficulty of accurately determining the chaindown slope from data such as that indicated in graph 910 or 920.

For example, given the nature of such data in practical applications, such as where the data may have some amount of variance/fluctuation due to various factors (e.g., noise, amplitude variances, misalignments, etc.), such as indicated by the variances/oscillations in the plots 911 and 921, the accuracy of the determination of the chaindown slope may be affected. Such limited accuracy in the determination of the chaindown slope may result in limited accuracy in the determination of the offset value (e.g., that corresponds to the radial offset of the scale portion or the detector portion), and correspondingly of the correction process which results in the error curve plot 933 which indicates the remaining error. Such characteristics may result at least in part from certain dimensional relationships in the implementation of FIGS. 6 and 7, for which in contrast the implementation of FIGS. 3A and 4 may provide improved characteristics that provide sufficient accuracy for certain practical applications, as will be described in more detail below.

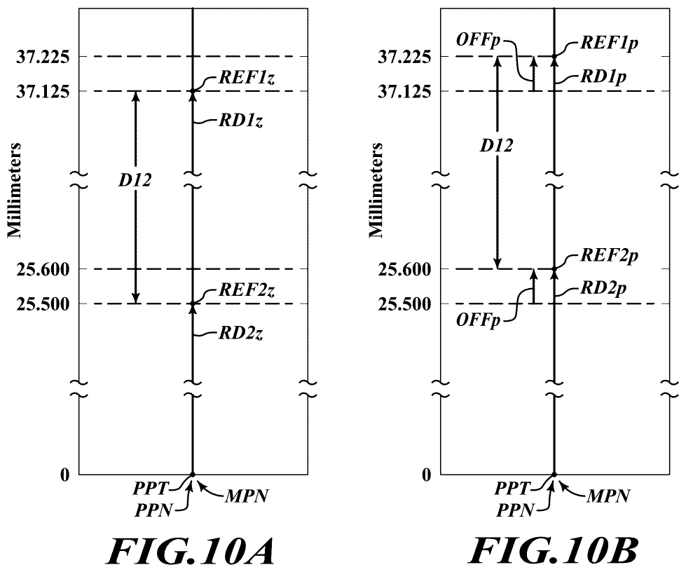

FIGS. 10A-10B are diagrams illustrating an offset (e.g., a radial offset of the scale portion or the detector portion) in relation to certain features of FIGS. 3A and 4. FIGS. 10A and 10B are noted to have certain similarities to FIGS. 8A and 8B. FIG. 10A may be compared to and generally corresponds to a representation of portions of the vertical centerline of FIG. 4. In the illustration of FIG. 10A (e.g., which in various implementations may correspond to a condition of zero radial offset), the first central reference point REF1_{Z} (e.g., located at a central x and/or y-axis location, such as at a centerline CL1, of the first scale element portion PRTSC1 of the first scale track ST1 and/or of the first sensing element portion PRTSEN1) is at a radial distance RD1_{Z} from the pivot portion PPN. The second central reference point REF2_{Z} (e.g., located at a central x and/or y-axis location, such as at a centerline CL2, of the second scale element portion PRTSC2 of the second scale track ST2 and/or of the second sensing element portion PRTSEN2) is at a radial distance RD2_{Z} from the pivot portion PPN.

A difference distance D12 is indicated as a difference in distance between the central reference points REF1_{Z} and REF2_{Z}, and is correspondingly also a difference between the first radial distance RD1_{Z} and the second radial distance RD2_{Z}. As some specific numerical examples, the illustrations in FIG. 10A indicate the first radial distance RD1_{Z} may be 37.125 mm, the second radial distance RD2_{Z} may be 25.5 mm (e.g., as corresponding to a numerical example described above with respect to FIGS. 3A and 4), and for which correspondingly the difference distance D12 may be 11.625 mm. As noted above, in the illustration of FIG. 4, the numerical examples may further include that the first scale track width STW1 may be 4.0 mm, the second scale track width STW2 may be 2.75 mm and the separation distance SEP12 may be 8.25 mm.

FIG. 10B illustrates a condition with an offset OFF_{P} (e.g., a radial offset of the scale portion or the detector portion). In the illustration of FIG. 10B (e.g., which in various implementations may correspond to a condition of a positive radial offset OFF_{P}), a first central reference point REF1_{P} (e.g., of the first scale element portion PRTSC1 of the first scale track ST1) has been shifted upward by the offset OFF_{P} so as to be at a radial distance RD1_{P} from the pivot portion PPN. The second central reference point REF2_{P} (e.g., of the second scale element portion PRTSC2 of the second scale track ST2) has correspondingly also been shifted upward by the offset OFF_{P} (e.g., due to the first and second scale element portions and corresponding scale tracks being fabricated on a single PCB that may be coupled to the support member MEPSM of FIG. 2 such that the scale portion as a whole may have a radial offset OFF_{P}) so as to be at a radial distance RD2_{P} from the pivot portion PPN. It is noted that the difference distance D12 is indicated as being the same in FIG. 10B as it was in FIG. 10A (e.g., for which in certain implementations the constant known difference distance D12 and/or corresponding characteristics may be regarded as being utilized as an internal reference for performing self-correction as described herein).

It is also noted that while in this example the scale portion may have a radial offset as indicated, the detector portion including the sensing portion may remain with central reference points REF1_{Z} and REF2_{Z} at positions such as indicated in FIG. 10A. Thus, the radial offset of the scale portion may in some implementations be referenced as being in relation to the detector portion including the sensing portion (e.g., and for which in some implementations the detector portion including the sensing portion may also be referenced as having a radial offset in relation to the scale portion). In an alternative example, the described positions may be switched, with the scale portion remaining with the central reference points REF1_{Z} and REF2_{Z} at positions such as indicated in FIG. 10A, and with the sensing portion with the central reference points REF1_{P} and REF2_{P} at positions such as indicated in FIG. 10B (e.g., for which the sensing portion may be stated to have a radial offset in relation to the scale portion and/or the scale portion may be stated to have a radial offset in relation to the sensing portion). As some specific numerical examples, the illustrations in FIG. 10B indicate the first radial distance RD1_{P} may be 37.225 mm, the second radial distance RD2_{P} may be 25.6 mm (e.g., as corresponding to the positive radial offset OFF_{P} which may be 0.1 mm). The constant difference distance D12 may continue to be 11.625 mm.

FIGS. 11A-11C are diagrams of graphs 1110-1130 illustrating certain data resulting from the operations and a correction process of the transducer of FIGS. 3A and 4 with an offset such as that illustrated in FIGS. 10A-10B. The x-axis of the graphs 1110-1130 is in terms of arc distance along the first scale track TR1. The graphs 1110-1130 have certain similarities to the graphs 910-930 of FIGS. 9A-9C, and will be understood based at least in part on the descriptions of FIGS. 9A-9C, except as otherwise described below.

FIG. 11A is a graph 1110 of a chaindown curve plot 1111 of chaindown values for a direct chaindown process. FIG. 11B is a graph 1120 of a chaindown curve plot 1121 of chaindown values for a double chaindown process. It will be appreciated (e.g., as indicated by EQUATIONS 17-20) that the chaindown slope in FIG. 11B (i.e., for the double chaindown process) may be ½ of the chaindown slope in FIG. 11A (i.e., for the direct chaindown process), in accordance with the inclusion of the m variable (e.g., as equal to 2 in the current examples) in the denominator of the chaindown slope equations for the double chaindown process. As a specific numerical example in relation to EQUATION 17, if an offset OFF to be determined is approximately 0.1 mm, and with RD1=37.125 mm, RD2=25.5 mm and n=25, then EQUATION 17 indicates CDSLOPE_{DIR} should be ≈0.03, which is approximately the chaindown slope observed in the chaindown curve plot 1111, and which could therefore be utilized to approximately determine the offset OFF.

FIG. 11C is a graph 1130 illustrating a long range error curve plots 1131 and 1133, where the long range error curve plot 1131 represents data before a correction process, and long range error curve plot 1133 represents data after a correction process has been performed according to principles as described herein (e.g., in accordance with EQUATION 21 and/or other processes). More specifically, in various implementations the chaindown slope may be determined based on data such as that indicated in either graph 1110 or 1120. As an example, in one specific implementation the determination of the chaindown slope may include applying a least-squares linear fit to the data.

The determined chaindown slope may be utilized to determine an offset value OFF (e.g., that corresponds to a radial offset of the scale portion or the detector portion), such as in accordance with an equation (e.g., one of EQUATIONS 17-20) or other calculation or method that enables a determination of an offset value based on a determined chaindown slope or otherwise based on chaindown data. The determined offset value may be utilized to correct one or more values that are utilized to determine a relative position between the detector portion and the scale portion. For example, the determined offset value may be utilized in accordance with EQUATION 21 or other calculation for correcting a spatial step value or other spatial value of the scale portion, which may then be utilized in one or more equations (e.g., such as EQUATION 12) or other calculation for determining a measurement (i.e., which corresponds to a relative position between the detector portion and the scale portion).

As noted above, the long range error curve plot 1133 represents data after such a correction process has been performed. The plot 1133 with the correction (i.e., with a remaining slope of approximately −0.2 μm error per mm of measurement) indicates significant improvement relative to the original error plot 1131 (i.e., with a slope of approximately −2.67 μm error per mm of measurement). This may be more than sufficient for certain practical applications (e.g., as contrasted with the results indicated in FIGS. 9A-9C, where significantly higher error levels remained after the correction process). Such improved characteristics of FIGS. 11A-11C may result at least in part due to certain dimensional relationships in the implementation of FIGS. 3A and 4, as compared to the implementation of FIGS. 6 and 7.

As noted above, a key aspect of the implementation of FIGS. 3A and 4 is the large separation of the scale tracks. In regard to certain relationships (e.g., as indicated by EQUATIONS 17-20), the large separation of the scale tracks in certain examples may be represented by the relationship (1/RD2)−(1/RD1). With the example values of the implementation of FIGS. 3A and 4 of RD2=25.5 mm and RD1=37.125 mm, the (1/RD2)−(1/RD1)=0.01228 mm⁻¹, which corresponds to the desirable results of FIGS. 11A-11C. This may be contrasted with the implementation of FIGS. 6 and 7, for which with the example values of RD2=32.5 mm and RD1=37.125 mm, the (1/RD2)−(1/RD1)=0.00383 mm⁻¹. It is noted that the 0.01228 mm⁻¹ factor is approximately 3.2× better for the correction process than the 0.00383 mm⁻¹ factor. In certain implementations, it may be desirable for the (1/RD2)−(1/RD1) factor to be at least 0.01 mm⁻¹.

Another way to represent/characterize the large separation of the scale tracks is according to the ratio RD1/RD2. In the implementation of FIGS. 3A and 4, RD1/RD2=1.456. This may be contrasted with the implementation of FIGS. 6 and 7 where RD1/RD2=1.142. In certain implementations, it may be desirable for the ratio of RD1/RD2 to be at least 1.4.

Another way to represent/characterize the large separation of the scale tracks is according to the separation distance SEP12 between the first and second scale tracks, such as in relation to the widths of the first and/or second scale tracks. In the implementation of FIGS. 6 and 7, it is noted that the separation distance SEP12 is 1.25 mm, which is less than the first and second scale track widths of 4.0 mm and 2.75 mm, respectively. In contrast, in the implementation of FIGS. 3A and 4, the separation distance SEP12 is 8.25 mm, which is greater than the widths of the first and/or second scale tracks. In various implementations, it may be desirable for the separation distance SEP12 to be greater than the first scale track width and greater than the second scale track width. In various implementations, it may be desirable for the separation distance SEP12 to be greater than the first and second scale track widths combined. In various implementations, it may be desirable for the separation distance SEP12 to be greater than a multiple of the second scale track width, such as greater than 2 times the second scale track width. In various implementations, it may further be desirable for a separation area between the first and second scale tracks to have a width defined by the separation distance SEP12 and for which the separation area is relatively empty (e.g., it does not include a scale element portion arranged in a track portion with a sensing element portion).

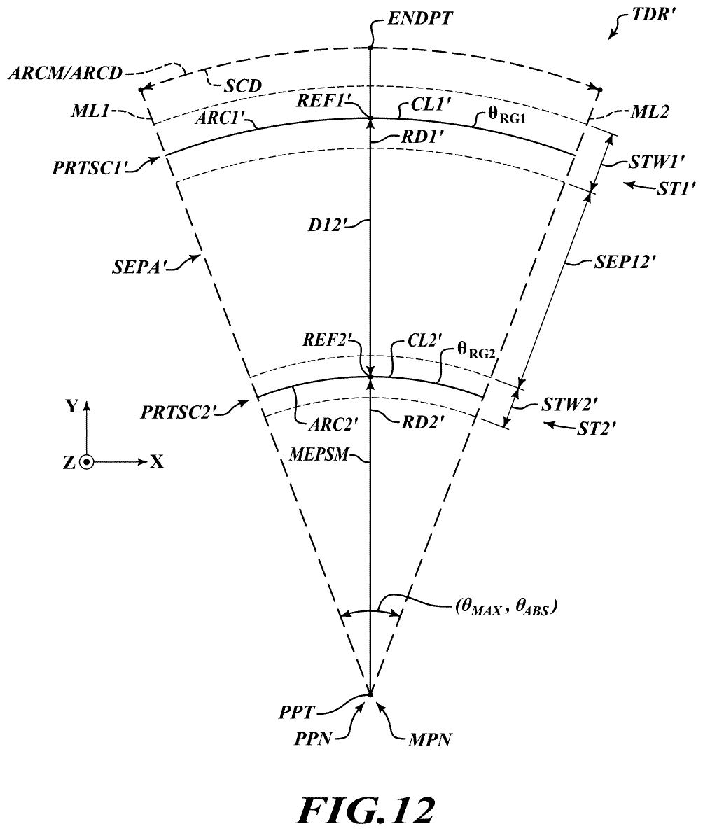

FIG. 12 is a diagram illustrating certain dimensions and features of the measuring instrument of FIG. 2 and a portion of a transducer TDR′ configured to be utilized with arc motion between a detector portion and a scale portion such as may be utilized in the measuring instrument of FIG. 2 and having a second large separation of the scale tracks. The transducer TDR′ of FIG. 12 is configured to produce similar signals as the transducer TDR of FIGS. 3A and 4, and for which FIG. 5 is representative of signals resulting from the operation of the implementation of FIG. 12, as well as being representative of signals resulting from the operation of the implementation of FIGS. 3A and 4. In this regard, during operations, the signals of the implementation of FIG. 12 may be similar to the signals SIG1A, SIG1B, SIG2A and SIG2B of the implementation of FIG. 3A.

Also, each of the components of the transducer TDR of FIG. 3A will be understood to have a corresponding component in the transducer TDR′ of FIG. 12 (e.g., as may be designated with a prime ‘). As such, the components of the transducer TDR’ will be understood by one skilled in the art based on the corresponding components of the transducer TDR, except as otherwise described below. As such, a complete description of the components of the transducer TDR′ will not be provided herein. A primary difference of the transducer TDR′ as compared to the transducer TDR is certain dimensional relationships, some of which will be described in more detail below.

In the transducer of FIG. 12, the first scale element portion PRTSC1′ is within a first scale track ST1′ having a first scale track width STW1′ (e.g., for which the upper and lower edges of the first scale element portion PRTSC1′ may correspond to the upper and lower boundaries of the first scale track ST1′). The second scale element portion PRTSC2′ is within a second scale track ST2′ having a second scale track width STW2′ (e.g., for which the upper and lower edges of the second scale element portion PRTSC2′ may correspond to the upper and lower boundaries of the second scale track ST2′). A separation distance SEP12′ is illustrated as a radial distance between the first and second scale tracks ST1′ and ST2′. A separation area SEPA′ is illustrated between the first and second scale tracks ST1′ and ST2′ (e.g., having a radial width defined by the separation distance SEP12′, and such as defined by the lower boundary of the first scale track ST1′ and the upper boundary of the second scale track ST2′). The separation area SEPA′ is empty (e.g., as not including a scale element portion as arranged in an encoder track portion with a sensing element portion).

The second scale element portion PRTSC2′ of the second scale track ST2′, such as included as part of a second encoder track portion, is closer to the pivot portion PPN than the first scale element portion PRTSC1′ of the first scale track ST1′, such as included as part of a first encoder track portion (e.g., such that a radial distance RD2′ of a second central reference point REF2′ of the second scale element portion PRTSC2′ of the second scale track ST2′ of the second encoder track portion is smaller than a radial distance RD1′ of a first central reference point REF1′ of the first scale element portion PRTSC1′ of the first scale track ST1′ of the first encoder track portion). In various implementations, the reference point REF1′ may be at the centerline CL1′ and the reference point REF2′ may be at the centerline CL2′. A difference distance D12′ is indicated as a difference in distance between the central reference points REF1′ and REF2′, and is correspondingly also a difference between the first radial distance RD1′ and the second radial distance RD2′.

The first scale element portion PRTSC1′ has a first angular range θ_{RG1} and a corresponding arc length ARC1′, and the second scale element portion PRTSC2″ has a second angular range θ_{RG2} and a corresponding arc length ARC2′. The angular ranges θ_{RG1} and θ_{RG2} are indicated as being nominally equal, and in the example of FIG. 12 are indicated as being nominally equal to the absolute angular measurement range θ_{ABS} and to the maximum angular movement range θ_{MAX}. In these examples, the arc lengths may be determined according to a standard arc length equation, such as ARC1′=RD1′ (θ_{ABS}) and ARC2′=RD2′ (θ_{ABS}) (e.g., where θ_{ABS} has a value in radians). As some specific example dimensions, in one implementation the first scale track width STW1′ may be 4.0 mm, the second scale track width STW2′ may be 2.75 mm, the separation distance SEP12′ may be 13.85 mm, the first radial distance RD1′ may be 38.725 mm, the second radial distance RD2′ may be 21.5 mm and the difference distance D12′ may be 17.225 mm. In various implementations, such dimensions may result in certain desirable operating characteristics, as will be described in more detail below.

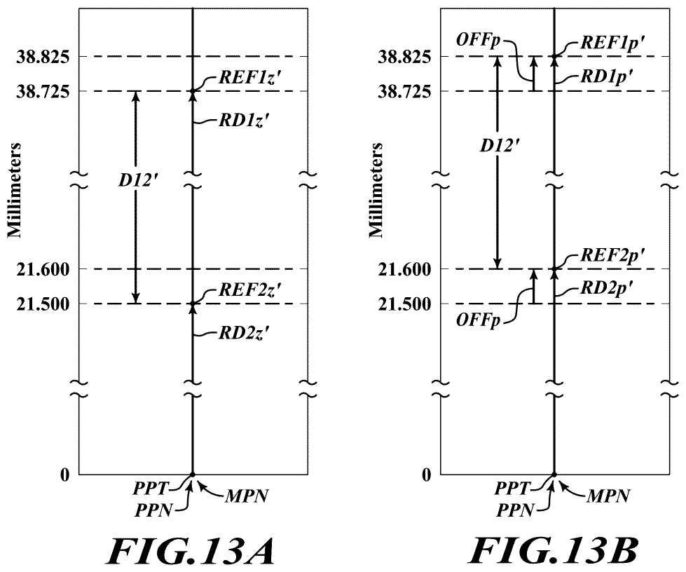

FIGS. 13A-13B are diagrams illustrating an offset (e.g., a radial offset of the scale portion or the detector portion) in relation to certain features of FIG. 12. FIGS. 13A and 13B are noted to be similar to FIGS. 10A and 10B, and will be understood based on the description of FIGS. 10A and 10B, except as otherwise noted below. The primary difference of FIGS. 13A and 13B is the numerical examples of the dimensions, which will be described in more detail below. In the illustration of FIG. 13A (e.g., which in various implementations may correspond to a condition of zero radial offset), the first central reference point REF1_{Z}′ is at a radial distance RD1_{Z}′ from the pivot portion PPN. The second central reference point REF2_{Z}′ is at a radial distance RD2_{Z}′ from the pivot portion PPN.

As some specific numerical examples, the illustrations in FIG. 13A indicate the first radial distance RD1_{Z}′ may be 38.725 mm, the second radial distance RD2_{Z}′ may be 21.5 mm (e.g., as corresponding to a numerical example described above with respect to FIG. 12), and for which correspondingly the difference distance D12′ may be 17.225 mm. As noted above, in the illustration of FIG. 12, the numerical examples may further include that the first scale track width STW1′ may be 4.0 mm, the second scale track width STW2′ may be 2.75 mm and the separation distance SEP12′ may be 13.85 mm.

In the illustration of FIG. 13B (e.g., which in various implementations may correspond to a condition of a positive radial offset OFF_{P}), a first central reference point REF1_{P}′ (e.g., of the first scale element portion PRTSC1′ of the first scale track ST1′) has been shifted upward by the offset OFF_{P} so as to be at a radial distance RD1_{P}′ from the pivot portion PPN. The second central reference point REF2_{P}′ (e.g., of the second scale element portion PRTSC2′ of the second scale track ST2′) has correspondingly also been shifted upward by the offset OFF_{P} so as to be at a radial distance RD2_{P}′ from the pivot portion PPN. It is noted that the difference distance D12′ is indicated as being the same in FIG. 13B as it was in FIG. 13A (e.g., for which in certain implementations the constant known difference distance D12′ and/or corresponding characteristics may be regarded as being utilized as an internal reference for performing self-correction as described herein).

It is also noted that while in this example the scale portion may have a radial offset as indicated, the detector portion including the sensing portion may remain with central reference points REF1_{Z}′ and REF2_{Z}′ at positions such as indicated in FIG. 13A. Thus, the radial offset of the scale portion may in some implementations be referenced as being in relation to the detector portion including the sensing portion (e.g., and for which in some implementations the detector portion including the sensing portion may also be referenced as having a radial offset in relation to the scale portion). In an alternative example, the described positions may be switched, with the scale portion remaining with the central reference points REF1_{Z}′ and REF2_{Z}′ at positions such as indicated in FIG. 13A, and with the sensing portion with the central reference points REF1_{P}′ and REF2_{P}′ at positions such as indicated in FIG. 13B (e.g., for which the sensing portion may be stated to have a radial offset in relation to the scale portion and/or the scale portion may be stated to have a radial offset in relation to the sensing portion). As some specific numerical examples, the illustrations in FIG. 13B indicate the first radial distance RD1_{P}′ may be 38.825 mm, the second radial distance RD2_{P}′ may be 21.6 mm (e.g., as corresponding to the positive radial offset OFF_{P} which may be 0.1 mm). The constant difference distance D12′ may continue to be 17.225 mm.

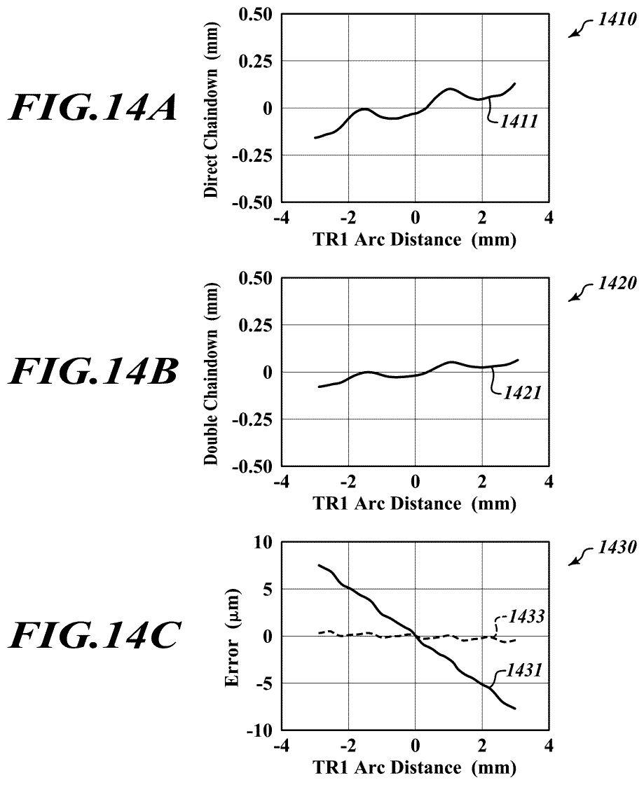

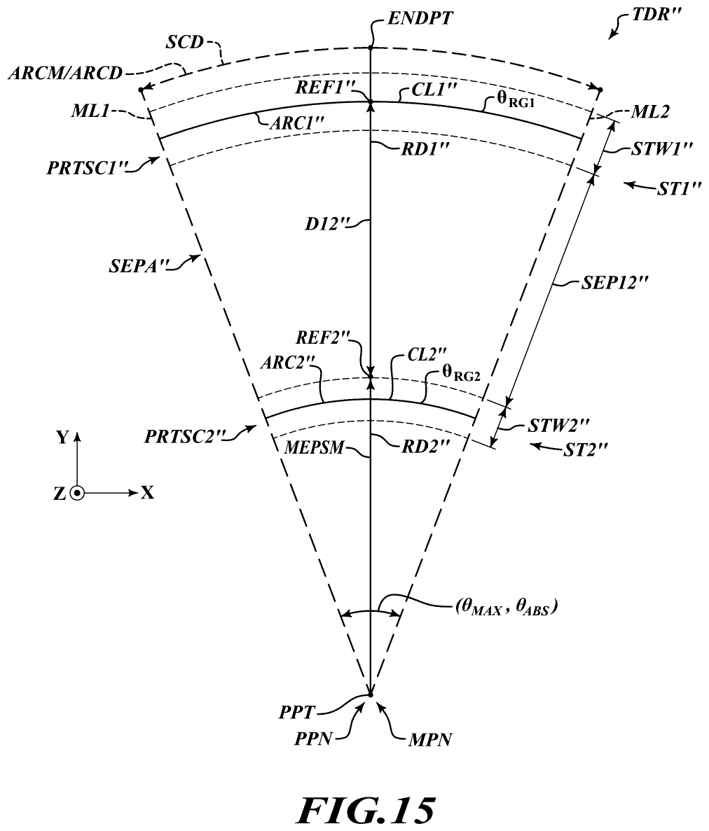

FIGS. 14A-14C are diagrams of graphs 1410-1430 illustrating certain data resulting from the operations and a correction process of the transducer of FIG. 12 with an offset such as that illustrated in FIGS. 13A-13B. The x-axis of the graphs 1410-1430 is in terms of arc distance along the first scale track TR1. The graphs 1410-1430 have certain similarities to the graphs 1110-1130 of FIGS. 11A-11C, and will be understood based at least in part on the descriptions of FIGS. 11A-11C, except as otherwise described below.

FIG. 14A is a graph 1410 of a chaindown curve plot 1411 of chaindown values for a direct chaindown process. FIG. 14B is a graph 1420 of a chaindown curve plot 1421 of chaindown values for a double chaindown process. As a specific numerical example in relation to EQUATION 17, if an offset OFF to be determined is approximately 0.1 mm, and with RD1=38.725 mm, RD2=21.5 mm and n=25, then EQUATION 17 indicates CDSLOPE_{DIR} should be ≈0.05, which is approximately the chaindown slope observed in the chaindown curve plot 1411, and which could therefore be utilized to approximately determine the offset OFF.

FIG. 14C is a graph 1430 illustrating a long range error curve plots 1431 and 1433, where the long range error curve plot 1431 represents data before a correction process, and long range error curve plot 1433 represents data after a correction process has been performed according to principles as described herein (e.g., in accordance with EQUATION 21 and/or other processes). More specifically, in various implementations the chaindown slope may be determined based on data such as that indicated in either graph 1410 or 1420. As an example, in one specific implementation the determination of the chaindown slope may include applying a least-squares linear fit to the data.

The determined chaindown slope may be utilized to determine an offset value OFF (e.g., that corresponds to a radial offset of the scale portion or the detector portion), such as in accordance with an equation (e.g., one of EQUATIONS 17-20) or other calculation or method that enables a determination of an offset value based on a determined chaindown slope or otherwise based on chaindown data. The determined offset value may be utilized to correct one or more values that are utilized to determine a relative position between the detector portion and the scale portion. For example, the determined offset value may be utilized in accordance with EQUATION 21 or other calculation for correcting a spatial step value or other spatial value of the scale portion, which may then be utilized in one or more equations (e.g., such as EQUATION 12) or other calculation for determining a measurement (i.e., which corresponds to a relative position between the detector portion and the scale portion).

As noted above, the long range error curve plot 1433 represents data after such a correction process has been performed. The plot 1433 with the correction (i.e., with a remaining slope of approximately −0.1 μm error per mm of measurement) indicates significant improvement relative to the original error plot 1431 (i.e., with a slope of approximately −2.67 μm error per mm of measurement). This may be more than sufficient for certain practical applications (e.g., as contrasted with the results indicated in FIGS. 9A-9C, where significantly higher error levels remained after the correction process). Such improved characteristics of FIGS. 14A-14C may result at least in part due to certain dimensional relationships in the implementation of FIGS. 12-13B as compared to the implementation of FIGS. 6 and 7.

In accordance with principles as described herein, a key aspect of the implementation of FIGS. 12-13B is the large separation of the scale tracks. In regard to certain relationships (e.g., as indicated by EQUATIONS 17-20), the large separation of the scale tracks in certain examples may be represented by the relationship (1/RD2)−(1/RD1). With the example values of the implementation of FIGS. 12-13B of RD2=21.5 mm and RD1=38.725 mm, the (1/RD2)−(1/RD1)=0.02069 mm⁻¹, which corresponds to the desirable results of FIGS. 14A-14C. This may be contrasted with the implementation of FIGS. 6 and 7, for which with the example values of RD2=32.5 mm and RD1=37.125 mm, the (1/RD2)−(1/RD1)=0.00383 mm⁻¹. In certain implementations, it may be desirable for the (1/RD2)−(1/RD1) factor to be at least 0.01 mm⁻¹, or at least 0.015 mm⁻¹.

Another way to represent/characterize the large separation of the scale tracks is according to the ratio RD1/RD2. In the implementation of FIGS. 12-13B, RD1/RD2=1.801. This may be contrasted with the implementation of FIGS. 6 and 7 where RD1/RD2=1.142. In certain implementations, it may be desirable for the ratio of RD1/RD2 to be at least 1.4, or at least 1.5.

Another way to represent/characterize the large separation of the scale tracks is according to the separation distance SEP12 between the first and second scale tracks, such as in relation to the widths of the first and/or second scale tracks. In the implementation of FIGS. 6 and 7, it is noted that the separation distance SEP12 is 1.25 mm, which is less than the first and second scale track widths of 4.0 mm and 2.75 mm, respectively. In contrast, in the implementation of FIGS. 12-13B, the separation distance SEP12 is 13.85 mm, which is greater than the widths of the first and/or second scale tracks. In various implementations, it may be desirable for the separation distance SEP12 to be greater than the first scale track width and greater than the second scale track width. In various implementations, it may be desirable for the separation distance SEP12 to be greater than the first and second scale track widths combined. In various implementations, it may be desirable for the separation distance SEP12 to be greater than a multiple of the second scale track width, such as greater than 2 times the second scale track width, or greater than 3 times the second scale track width.

FIG. 15 is a diagram illustrating certain dimensions and features of the measuring instrument of FIG. 2 and a portion of a transducer TDR″ configured to be utilized with arc motion between a detector portion and a scale portion such as may be utilized in the measuring instrument of FIG. 2 and having a second large separation of the scale tracks. The transducer TDR″ of FIG. 15 may have certain different design features (e.g., with n=60 and m=2 and corresponding spatial step relationships in accordance with EQUATION 1) but may otherwise be configured to operate substantially similarly to the transducer TDR of FIGS. 3A and 4. As such, the components of the transducer TDR″ will be understood by one skilled in the art based on the corresponding components of the transducer TDR, except as otherwise described below. As such, a complete description of the components of the transducer TDR″ will not be provided herein. Certain differences of the transducer TDR″ as compared to the transducer TDR are certain dimensional relationships, some of which will be described in more detail below.

In the transducer of FIG. 15, the first scale element portion PRTSC1″ is within a first scale track ST1″ having a first scale track width STW1″ (e.g., for which the upper and lower edges of the first scale element portion PRTSC1″ may correspond to the upper and lower boundaries of the first scale track ST1″). The second scale element portion PRTSC2″ is within a second scale track ST2″ having a second scale track width STW2″ (e.g., for which the upper and lower edges of the second scale element portion PRTSC2″ may correspond to the upper and lower boundaries of the second scale track ST2″). A separation distance SEP12″ is illustrated as a radial distance between the first and second scale tracks ST1″ and ST2″. A separation area SEPA″ is illustrated between the first and second scale tracks ST1″ and ST2″ (e.g., having a radial width defined by the separation distance SEP12″, and such as defined by the lower boundary of the first scale track ST1″ and the upper boundary of the second scale track ST2″). The separation area SEPA″ is empty (e.g., as not including a scale element portion as arranged in an encoder track portion with a sensing element portion).

The second scale element portion PRTSC2″ of the second scale track ST2″, such as included as part of a second encoder track portion, is closer to the pivot portion PPN than the first scale element portion PRTSC1″ of the first scale track ST1″, such as included as part of a first encoder track portion (e.g., such that a radial distance RD2″ of a second central reference point REF2″ of the second scale element portion PRTSC2″ of the second scale track ST2″ of the second encoder track portion is smaller than a radial distance RD1″ of a first central reference point REF1″ of the first scale element portion PRTSC1″ of the first scale track ST1″ of the first encoder track portion). In various implementations, the reference point REF1″ may be at the centerline CL1″ and the reference point REF2″ may be at the centerline CL2″. A difference distance D12″ is indicated as a difference in distance between the central reference points REF1″ and REF2″, and is correspondingly also a difference between the first radial distance RD1″ and the second radial distance RD2″.

The first scale element portion PRTSC1″ has a first angular range θ_{RG1} and a corresponding arc length ARC1″, and the second scale element portion PRTSC2″ has a second angular range θ_{RG2} and a corresponding arc length ARC2″. The angular ranges θ_{RG1} and θ_{RG2} are indicated as being nominally equal, and in the example of FIG. 15 are indicated as being nominally equal to the absolute angular measurement range θ_{ABS} and to the maximum angular movement range θ_{MAX}. In these examples, the arc lengths may be determined according to a standard arc length equation, such as ARC1″=RD1″ (θ_{ABS}) and ARC2″=RD2″(θ_{ABS}) (e.g., where θ_{ABS} has a value in radians). As some specific example dimensions, in one implementation the first scale track width STW1″ may be 4.0 mm, the second scale track width STW2″ may be 2.75 mm, the separation distance SEP12″ may be 16.625 mm, the first radial distance RD1″ may be 40 mm, the second radial distance RD2″ may be 20 mm and the difference distance D12″ may be 20 mm. In various implementations, such dimensions may result in certain desirable operating characteristics, as will be described in more detail below.

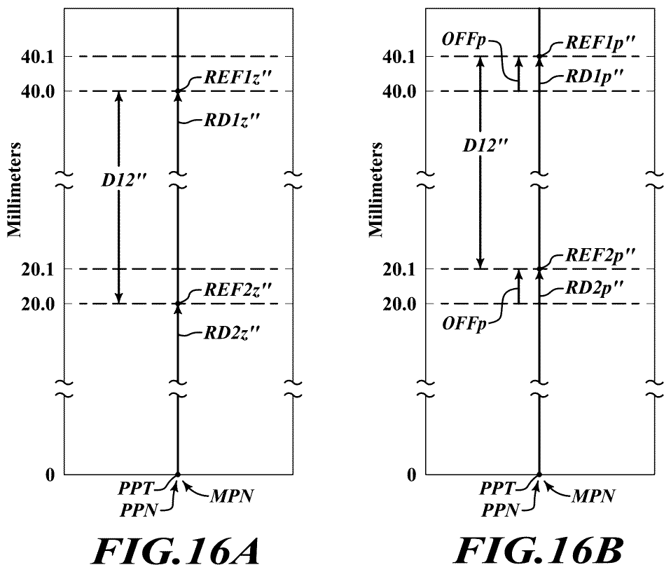

FIGS. 16A-16B are diagrams illustrating an offset (e.g., a radial offset of the scale portion) in a first direction (e.g., in a positive direction) in relation to certain features of FIG. 15. FIGS. 16A and 16B are noted to be similar to FIGS. 10A and 10B, and will be understood based on the description of FIGS. 10A and 10B, except as otherwise noted below. The primary difference of FIGS. 16A and 16B is the numerical examples of the dimensions, which will be described in more detail below. In the illustration of FIG. 16A (e.g., which in various implementations may correspond to a condition of zero radial offset), the first central reference point REF1_{Z}″ is at a radial distance RD1_{Z}″ from the pivot portion PPN. The second central reference point REF2_{Z}″ is at a radial distance RD2_{Z}″ from the pivot portion PPN.

As some specific numerical examples, the illustrations in FIG. 16A indicate the first radial distance RD1_{Z}″ may be 40 mm, the second radial distance RD2_{Z}″ may be 20 mm (e.g., as corresponding to a numerical example described above with respect to FIG. 15), and for which correspondingly the difference distance D12″ may be 20 mm. As noted above, in the illustration of FIG. 15, the numerical examples may further include that the first scale track width STW1″ may be 4.0 mm, the second scale track width STW2″ may be 2.75 mm and the separation distance SEP12″ may be 16.625 mm.

In the illustration of FIG. 16B (e.g., which in various implementations may correspond to a condition of a positive radial offset OFF_{P}), a first central reference point REF1_{P}″ (e.g., of the first scale element portion PRTSC1″ of the first scale track ST1″) has been shifted upward by the offset OFF_{P} so as to be at a radial distance RD1_{P}″ from the pivot portion PPN. The second central reference point REF2_{P}″ (e.g., of the second scale element portion PRTSC2″ of the second scale track ST2″) has correspondingly also been shifted upward by the offset OFF_{P} so as to be at a radial distance RD2_{P}″ from the pivot portion PPN. It is noted that the difference distance D12″ is indicated as being the same in FIG. 16B as it was in FIG. 16A (e.g., for which in certain implementations the constant known difference distance D12″ and/or corresponding characteristics may be regarded as being utilized as an internal reference for performing self-correction as described herein).

It is also noted that while in this example the scale portion may have a radial offset as indicated, the detector portion including the sensing portion may remain with central reference points REF1_{Z}″ and REF2_{Z}″ at positions such as indicated in FIG. 16A. Thus, the radial offset of the scale portion may in some implementations be referenced as being in relation to the detector portion including the sensing portion (e.g., and for which in some implementations the detector portion including the sensing portion may also be referenced as having a radial offset in relation to the scale portion). In an alternative example, the described positions may be switched, with the scale portion remaining with the central reference points REF1_{Z}″ and REF2_{Z}″ at positions such as indicated in FIG. 16A, and with the sensing portion with the central reference points REF1_{P}″ and REF2_{P}″ at positions such as indicated in FIG. 16B (e.g., for which the sensing portion may be stated to have a radial offset in relation to the scale portion and/or the scale portion may be stated to have a radial offset in relation to the sensing portion). As some specific numerical examples, the illustrations in FIG. 16B indicate the first radial distance RD1_{P}″ may be 40.1 mm, the second radial distance RD2_{P}″ may be 20.1 mm (e.g., as corresponding to the positive radial offset OFF_{P} which may be 0.1 mm). The constant difference distance D12″ may continue to be 20 mm.

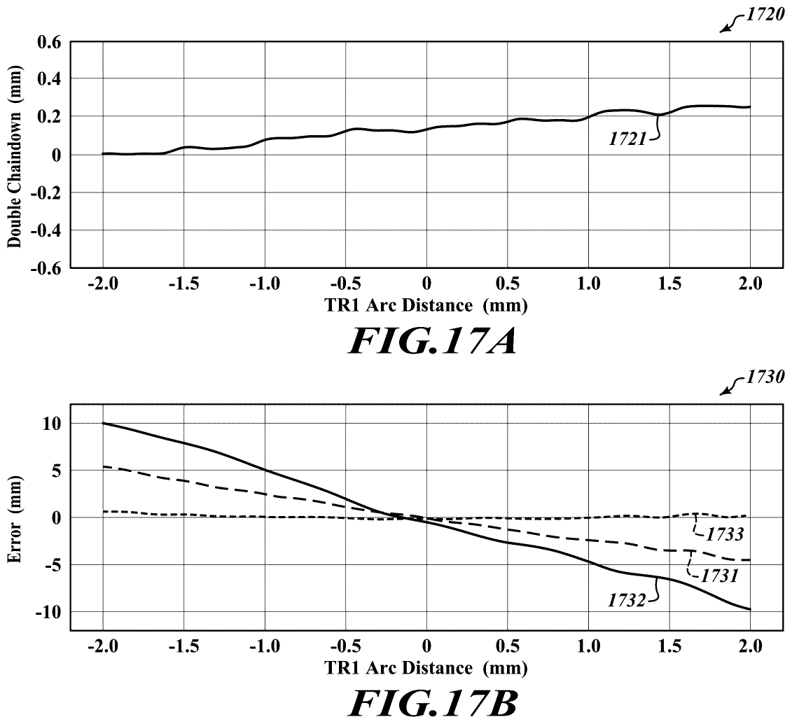

FIGS. 17A and 17B are diagrams of graphs 1720 and 1730, respectively, illustrating certain data resulting from the operations and a correction process of the transducer of FIG. 15 with an offset such as that illustrated in FIGS. 16A-16B. The x-axis of the graphs 1720 and 1730 is in terms of arc distance along the first scale track TR1. The graphs 1720 and 1730 have certain similarities to the graphs 1120 and 1130 of FIGS. 11B and 11C, and will be understood based at least in part on the descriptions of FIGS. 11B and 11C, except as otherwise described below.

FIG. 17A is a graph 1720 of a chaindown curve plot 1721 of chaindown values for a double chaindown process. As a specific numerical example in relation to EQUATION 19, if an offset OFF to be determined is approximately 0.1 mm, and with RD1=40 mm, RD2=20 mm, n=60 and m=2, then EQUATION 19 indicates CDSLOPE_{DIR} should be ≈0.075, which is approximately the chaindown slope observed in the chaindown curve plot 1721, and which could therefore be utilized to approximately determine the offset OFF.

FIG. 17B is a graph 1730 illustrating a long range error curve plots 1731, 1732 and 1733, where the long range error curve plot 1731 represents data from the first scale track before a correction process, the long range error curve plot 1732 represents data from the second scale track before a correction process, and the long range error curve plot 1733 represents data after a correction process has been performed according to principles as described herein (e.g., in accordance with EQUATION 21 and/or other processes). More specifically, in various implementations the chaindown slope may be determined based on data such as that indicated in graph 1720. As an example, in one specific implementation the determination of the chaindown slope may include applying a least-squares linear fit to the data.

The determined chaindown slope may be utilized to determine an offset value OFF (e.g., that corresponds to a radial offset of the scale portion or the detector portion), such as in accordance with an equation (e.g., one of EQUATIONS 19-20) or other calculation or method that enables a determination of an offset value based on a determined chaindown slope or otherwise based on chaindown data. The determined offset value may be utilized to correct one or more values that are utilized to determine a relative position between the detector portion and the scale portion. For example, the determined offset value may be utilized in accordance with EQUATION 21 or other calculation for correcting a spatial step value or other spatial value of the scale portion, which may then be utilized in one or more equations (e.g., such as EQUATION 12) or other calculation for determining a measurement (i.e., which corresponds to a relative position between the detector portion and the scale portion).

As noted above, the long range error curve plot 1733 represents data after such a correction process has been performed. The plot 1733 with the correction (i.e., with a remaining slope of approximately less than −0.1 μm error per mm of measurement) indicates significant improvement relative to the original error plot 1731 (i.e., with a slope of approximately −2.5 μm error per mm of measurement). This may be more than sufficient for certain practical applications (e.g., as contrasted with the results indicated in FIGS. 9A-9C, where significantly higher error levels remained after the correction process). Such improved characteristics of FIGS. 17A-17B may result at least in part due to certain dimensional relationships in the implementation of FIGS. 15-16B as compared to the implementation of FIGS. 6 and 7.

In accordance with principles as described herein, a key aspect of the implementation of FIGS. 15-16B is the large separation of the scale tracks. In regard to certain relationships (e.g., as indicated by EQUATIONS 19-20), the large separation of the scale tracks in certain examples may be represented by the relationship (1/RD2)−(1/RD1). With the example values of the implementation of FIGS. 15-16B of RD2=20 mm and RD1=40 mm, the (1/RD2)−(1/RD1)=0.02500 mm⁻¹, which corresponds to the desirable results of FIGS. 17A-17B. This may be contrasted with the implementation of FIGS. 6 and 7, for which with the example values of RD2=32.5 mm and RD1=37.125 mm, the (1/RD2)−(1/RD1)=0.00383 mm⁻¹. In certain implementations, it may be desirable for the (1/RD2)−(1/RD1) factor to be at least 0.01 mm⁻¹, or at least 0.015 mm⁻¹, or at least 0.017 mm⁻¹, or at least 0.020 mm⁻¹.

Another way to represent/characterize the large separation of the scale tracks is according to the ratio RD1/RD2. In the implementation of FIGS. 15-16B, RD1/RD2=2.0. This may be contrasted with the implementation of FIGS. 6 and 7 where RD1/RD2=1.142. In certain implementations, it may be desirable for the ratio of RD1/RD2 to be at least 1.4, or at least 1.5, or at least 1.6.

Another way to represent/characterize the large separation of the scale tracks is according to the separation distance SEP12 between the first and second scale tracks, such as in relation to the widths of the first and/or second scale tracks. In the implementation of FIGS. 6 and 7, it is noted that the separation distance SEP12 is 1.25 mm, which is less than the first and second scale track widths of 4.0 mm and 2.75 mm, respectively. In contrast, in the implementation of FIGS. 15-16B, the separation distance SEP12 is 16.625 mm, which is greater than the widths of the first and/or second scale tracks. In various implementations, it may be desirable for the separation distance SEP12 to be greater than the first scale track width and greater than the second scale track width. In various implementations, it may be desirable for the separation distance SEP12 to be greater than the first and second scale track widths combined. In various implementations, it may be desirable for the separation distance SEP12 to be greater than a multiple of the second scale track width, such as equal to or greater than 2 times the second scale track width, or equal to or greater than 3 times the second scale track width, or equal to or greater than 4 times the second scale track width.

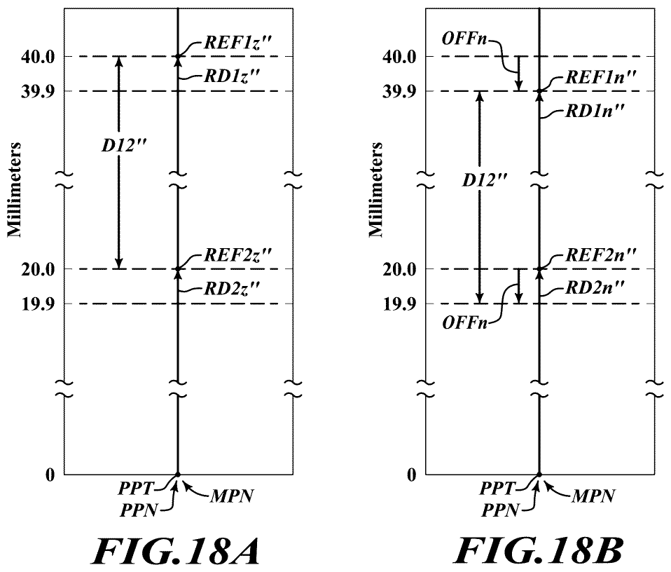

FIGS. 18A-18B are diagrams illustrating an offset (e.g., a radial offset of the scale portion) in a second direction (e.g., in a negative direction) in relation to certain features of FIG. 15. FIGS. 18A and 18B are noted to be similar to FIGS. 16A and 16B, and will be understood based on the description of FIGS. 16A and 16B, except with an offset OFFn in the negative direction, and except as otherwise noted below. In the illustration of FIG. 18A (e.g., which in various implementations may correspond to a condition of zero radial offset), the first central reference point REF1_{Z}″ is at a radial distance RD1_{Z}″ from the pivot portion PPN. The second central reference point REF2_{Z}″ is at a radial distance RD2_{Z}″ from the pivot portion PPN. FIG. 18A is noted to be identical to FIG. 16A, and will be understood based on the description of FIG. 16A above.

In the illustration of FIG. 18B (e.g., which in various implementations may correspond to a condition of a negative radial offset OFFn), a first central reference point REF1n″ (e.g., of the first scale element portion PRTSC1″ of the first scale track ST1″) has been shifted downward by the offset OFFn so as to be at a radial distance RD1n″ from the pivot portion PPN. The second central reference point REF2n″ (e.g., of the second scale element portion PRTSC2″ of the second scale track ST2″) has correspondingly also been shifted downward by the offset OFFn so as to be at a radial distance RD2n″ from the pivot portion PPN. It is noted that the difference distance D12″ is indicated as being the same in FIG. 18B as it was in FIGS. 16A and 18A (e.g., for which in certain implementations the constant known difference distance D12″ and/or corresponding characteristics may be regarded as being utilized as an internal reference for performing self-correction as described herein).

It is also noted that while in this example the scale portion may have a radial offset as indicated, the detector portion including the sensing portion may remain with central reference points REF1_{Z}″ and REF2_{Z}″ at positions such as indicated in FIGS. 16A and 18A. Thus, the radial offset of the scale portion may in some implementations be referenced as being in relation to the detector portion including the sensing portion (e.g., and for which in some implementations the detector portion including the sensing portion may also be referenced as having a radial offset in relation to the scale portion). In an alternative example, the described positions may be switched, with the scale portion remaining with the central reference points REF1_{Z}″ and REF2_{Z}″ at positions such as indicated in FIG. 18A, and with the sensing portion with the central reference points REF1n″ and REF2n″ at positions such as indicated in FIG. 18B (e.g., for which the sensing portion may be stated to have a radial offset in relation to the scale portion and/or the scale portion may be stated to have a radial offset in relation to the sensing portion). As some specific numerical examples, the illustrations in FIG. 18B indicate the first radial distance RD1n″ may be 39.9 mm, the second radial distance RD2n″ may be 19.9 mm (e.g., as corresponding to the positive radial offset OFFn which may be 0.1 mm). The constant difference distance D12″ may continue to be 20 mm.

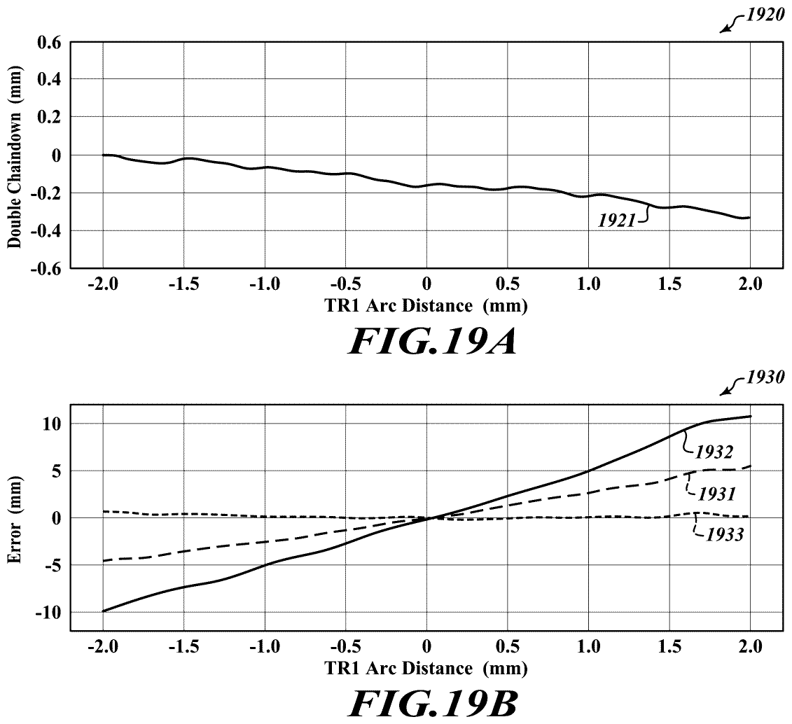

FIGS. 19A and 19B are diagrams of graphs 1920 and 1930, respectively, illustrating certain data resulting from the operations and a correction process of the transducer of FIG. 15 with an offset such as that illustrated in FIGS. 18A-18B. The x-axis of the graphs 1920 and 1930 is in terms of arc distance along the first scale track TR1. The graphs 1920 and 1930 have certain similarities to the graphs 1720 and 1730 of FIGS. 17A and 17B, except are directed to a condition with a negative offset rather than a positive offset. It will be appreciated that any of the implementations as described herein may similarly operate with negative offset (e.g., for which such operations may be comparable to the operations with a positive offset, as illustrated by comparing the operations of FIGS. 19A and 19B with the operations of FIGS. 17A and 17B).

FIG. 19A is a graph 1920 of a chaindown curve plot 1921 of chaindown values for a double chaindown process. As a specific numerical example in relation to EQUATION 19, if an offset OFF to be determined is approximately −0.1 mm (i.e., corresponding to a negative offset), and with RD1=40 mm, RD2=20 mm, n=60 and m=2, then EQUATION 19 indicates CDSLOPE_{DIR} should be ≈−0.075, which is approximately the chaindown slope observed in the chaindown curve plot 1921, and which could therefore be utilized to approximately determine the offset OFF.

FIG. 19B is a graph 1930 illustrating a long range error curve plots 1931, 1932 and 1933, where the long range error curve plot 1931 represents data from the first scale track before a correction process, the long range error curve plot 1932 represents data from the second scale track before a correction process, and the long range error curve plot 1933 represents data after a correction process has been performed according to principles as described herein (e.g., in accordance with EQUATION 21 and/or other processes). More specifically, in various implementations the chaindown slope may be determined based on data such as that indicated in graph 1920. As an example, in one specific implementation the determination of the chaindown slope may include applying a least-squares linear fit to the data.

The determined chaindown slope may be utilized to determine an offset value OFF (e.g., that corresponds to a radial offset of the scale portion or the detector portion), such as in accordance with an equation (e.g., one of EQUATIONS 19-20) or other calculation or method that enables a determination of an offset value based on a determined chaindown slope or otherwise based on chaindown data. The determined offset value may be utilized to correct one or more values that are utilized to determine a relative position between the detector portion and the scale portion. For example, the determined offset value may be utilized in accordance with EQUATION 21 or other calculation for correcting a spatial step value or other spatial value of the scale portion, which may then be utilized in one or more equations (e.g., such as EQUATION 12) or other calculation for determining a measurement (i.e., which corresponds to a relative position between the detector portion and the scale portion).

As noted above, the long range error curve plot 1933 represents data after such a correction process has been performed. The plot 1933 with the correction (i.e., with a remaining slope of approximately less than 0.1 um error per mm of measurement) indicates significant improvement relative to the original error plot 1931 (i.e., with a slope of approximately 2.5 um error per mm of measurement). This may be more than sufficient for certain practical applications (e.g., as contrasted with the results indicated in FIGS. 9A-9C, where significantly higher error levels remained after the correction process). Such improved characteristics of FIGS. 19A-19B may result at least in part due to certain dimensional relationships in the implementation of FIGS. 15-16B as compared to the implementation of FIGS. 6 and 7.

In accordance with principles as described herein, a key aspect of the implementation of FIGS. 15-16B is the large separation of the scale tracks. Various aspects and relationships in regard to the large separation of the scale tracks in the implementation of FIGS. 15-16B are described above following the description of FIGS. 17A and 17B.

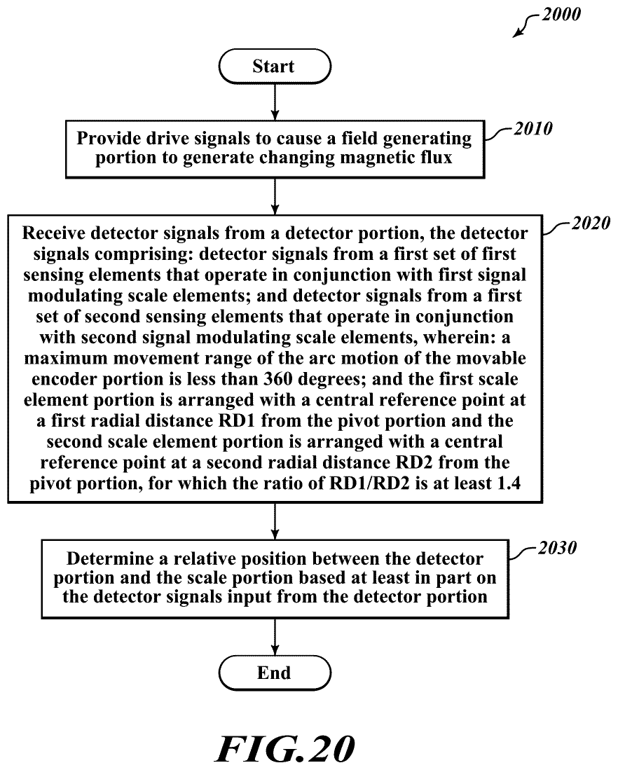

FIG. 20 is a flow diagram illustrating a method 2000 for operating a measuring instrument with arc motion for determining a relative position between a detector portion and a scale portion. Block 2010 includes providing drive signals to cause a field generating portion PRTFGE to generate changing magnetic flux. Block 2020 includes receiving detector signals from a detector portion 167, wherein the detector signals include: detector signals from a first set of first sensing elements SET1SEN1 that operate in conjunction with first signal modulating scale elements SME1; and detector signals from a first set of second sensing elements SET1SEN2 that operate in conjunction with second signal modulating scale elements SME2. A maximum movement range of the arc motion of the movable encoder portion is less than 360 degrees, and the first scale element portion is arranged with a central reference point at a first radial distance RD1 from the pivot portion and the second scale element portion is arranged with a central reference point at a second radial distance RD2 from the pivot portion, for which the ratio of RD1/RD2 is at least 1.4. Block 2030 includes determining a relative position between the detector portion 167 and the scale portion 170 based at least in part on the detector signals input from the detector portion 167.

In relation to the operations at the block 2030 for determining a relative position between the detector portion (167) and the scale portion (170) based at least in part on the detector signals from the detector portion, various processing and/or signal combining techniques may be utilized (e.g., as will be understood by one skilled in the art and at least in part in accordance with the teachings in the incorporated references). Briefly, in various implementations two drive operations may be utilized for producing and processing the signals from the detector portion. In various implementations, the two drive operations may be performed simultaneously, or with different timings.

More specifically, as part of a first drive operation, the first field generating element portion PRTFGE1 may be driven (e.g., with corresponding drive signals from the signal processing configuration 166). As the first field generating element portion PRTFGE1 is driven, corresponding signals (e.g., signals SIG1A and SIG1B) from the first sensing elements SEN1 of the first sensing element portion PRTSEN1 of the detector portion may be read (e.g., received, processed, etc.). As part of a second drive operation, the second field generating element portion PRTFGE2 may be driven (e.g., with corresponding drive signals from the signal processing configuration 166). As the second field generating element portion PRTFGE2 is driven, corresponding signals (e.g., signals SIG2A and SIG2B) from the second sensing elements SEN2 of the second sensing element portion PRTSEN2 of the detector portion may be read (e.g., received, processed, etc.). The detector signals (i.e., from the detector portion) produced during the first and second drive operations may be utilized to determine a relative position (e.g., an absolute position between the detector portion and the scale portion). In various implementations, the detector signals may include four signals (e.g., SIG1A, SIG1B, SIG2A, SIG2B) that may be utilized for determining the relative position, such as the signals SIG1A and SIG1B of the first drive operation, and the signals SIG2A and SIG2B of the second drive operation.

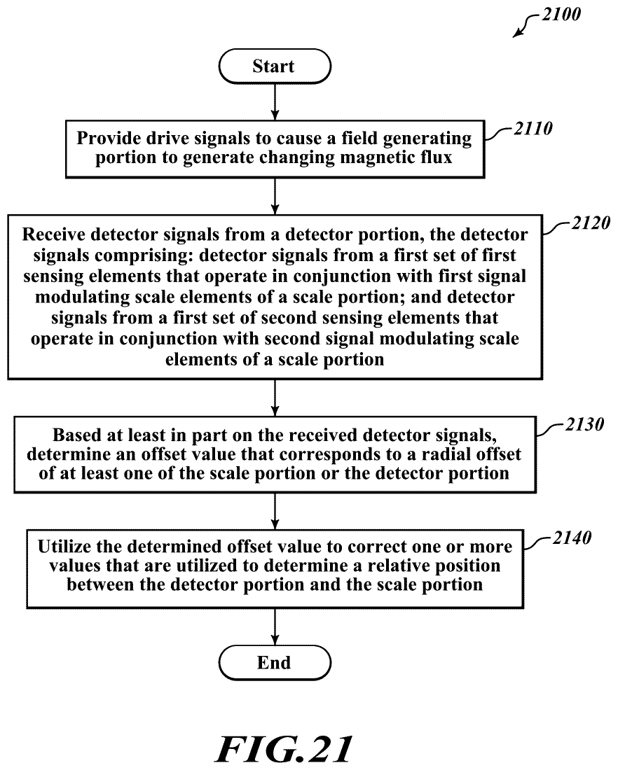

FIG. 21 is a flow diagram illustrating a method 2100 for a correction process for a measuring instrument with arc motion. Block 2110 includes providing drive signals to cause a field generating portion PRTFGE to generate changing magnetic flux. Block 2120 includes receiving detector signals from a detector portion 167, wherein the detector signals include: detector signals from a first set of first sensing elements SET1SEN1 that operate in conjunction with first signal modulating scale elements SME1; and detector signals from a first set of second sensing elements SET1SEN2 that operate in conjunction with second signal modulating scale elements SME2. Block 2130 includes determining, based at least in part on the received detector signals, an offset value that corresponds to a radial offset of a scale portion that includes the first signal modulating scale elements and the second signal modulating scale elements. Block 2140 includes utilizing the determined offset value to correct one or more values that are utilized to determine a relative position between the detector portion and the scale portion. For example, the determined offset value may be utilized in accordance with EQUATION 21 or other calculation for correcting a spatial step value or other spatial value of the scale portion, which may then be utilized in one or more equations (e.g., such as EQUATION 12) or other calculation or processing for determining a measurement (i.e., which corresponds to a relative position between the detector portion and the scale portion).

In various implementations, the determining of the offset value at block 2130 includes determining a difference slope (e.g., a chaindown slope). In various implementations, the difference slope may correspond to a slope of a difference between an absolute position signal and at least one of: a first position signal corresponding at least in part to detector signals from the first sensing elements (e.g., as part of a direct chaindown process as described herein); or a second position signal corresponding at least in part to detector signals from the second sensing elements (e.g., as part of a first step of a double chaindown process as described herein). In various implementations, the difference between the absolute position signal and the at least one of the first position signal or the second position signal corresponds at least in part to a difference between the phases of the respective signals (e.g., as indicated by EQUATIONS 9, 10, 14 and 15).

In various implementations, the utilizing of the determined offset value at block 2140 to correct one or more values includes at least in part dividing the determined offset value by at least a radial distance of the first scale element portion. For example, as indicated by EQUATION 21, where a correction value may be characterized as including the determined offset value OFF_{D} as divided by the radial distance RD1 of the first scale element portion, and as multiplied by a spatial step (e.g., θ_{WSME1}) of the first scale element portion. That correction value (i.e., corresponding to −θ_{WSME1} (OFF_{D}/RD1)) may then be added to the spatial step of the first scale element portion (e.g., added to θ_{WSME1}) in order to determine the corrected spatial step value θ_{WSME1C}, which is then subsequently utilized (e.g., in EQUATION 12 or other calculation) for the determination of a relative position between the detector portion and the scale portion (e.g., as part of measurement operations). In various implementations, the method 2100 (e.g., which the signal processing configuration is configured to perform) further includes determining an absolute relative position between the detector portion and the scale portion based at least in part on detector signals input from the detector portion, the detector signals including detector signals from the first set of first sensing elements and detector signals from the first set of second sensing elements (e.g., similar to block 2030 of FIG. 20, and as may correspond to entering a normal measurement mode for performing normal measurement operations after a calibration process is complete).

In general, in accordance with principles as described herein, in implementations configured such that the first radial distance of the first scale element portion and correspondingly of the first scale track has a large relative difference from the second radial distance of the second scale element portion and correspondingly of the second scale track (e.g., or otherwise where there is a large difference between the positions of the scale tracks), the effect of a radial offset/misalignment (e.g., of the scale portion in relation to the sensing portion of the detector portion) is also relatively large. The effect/difference can be seen, detected, etc. from a process that determines an integer number of spatial steps (e.g., corresponding to an integer number of signal modulating elements of a scale element portion of a scale track) as part of an absolute measurement determination. For example, as part of a chaindown process, a determination of an integer number of spatial steps includes a rounding process, for which the amounts that are rounded away are referenced as chaindown values. A determination may be made of a chaindown slope (e.g., which may be determined from a chaindown curve plot of the chaindown values or otherwise determined from the chaindown values) which can be utilized to determine an offset value (e.g., that corresponds to a radial offset of the scale portion, such as in relation to the sensing portion of the detector portion and/or in relation to the pivot portion or other reference, or that corresponds to a radial offset of the sensing portion of the detector portion, such as in relation to the scale portion and/or in relation to the pivot portion or other reference). The determined offset value may be utilized to correct one or more values that are utilized to determine a relative position between the detector portion and the scale portion. For example, a value (e.g., such as corresponding to a spatial step of a first scale element portion and correspondingly of a first scale track or an absolute measurement range or other spatial value that is utilized as part of an absolute measurement determination) may be corrected (e.g., as part of a correction and/or calibration process) and subsequently utilized as part of absolute measurement determinations (e.g., which correspond to determinations of a relative position between the detector portion and the scale portion).

In various implementations, the correction process may be performed as part of a calibration procedure (i.e., a calibration process). As part of such a process, the measuring instrument may be placed in a calibration mode (e.g., when the measuring instrument is first assembled, such as after the movable encoder portion MEP is coupled to the support member MEPSM, or at any other time when such calibration is to be performed). Measurement data (e.g., corresponding to detector signals received from the detector portion) may be collected in memory as the measuring instrument is moved with arc motion over a range of positions (e.g., with relative movement between the scale portion and the detector portion). The measurement data may be analyzed, and an offset value may be determined (e.g., as corresponding to a radial offset of the movable encoder portion MEP, which may correspond to a radial offset of the scale portion relative to the detector portion, or the detector portion relative to the scale portion, etc.). The determining of the offset value may include determining a difference slope (e.g., a chaindown slope). In various implementations, if the difference slope is very large, the data set may wrap around (e.g., such as jumping from −0.5 to +0.5 or from +0.5 to −0.5), for which a de-wrapping process may be performed or otherwise utilized so that a total difference slope can be determined. In various implementations, the offset value may be determined from the difference slope. The determined offset value may then be utilized to correct one or more values that are utilized to determine a relative position between the detector portion and the scale portion. When the calibration is complete, the measuring instrument may be placed in, or otherwise enter, a normal operating mode (e.g., during which accurate measurements may be determined based on the calibration having been performed). It will be appreciated that such calibration may help ensure the accuracy of the measuring instrument, in particular in regard to radial offsets that may be present (e.g., such as in regard to assembly and/or manufacturing tolerances for the components, such as in regard to the coupling of the movable encoder portion MEP to the support member MEPSM as may result in a radial offset in relation to the relative positions of the scale portion and the detector portion, etc.)

While certain of the examples as described herein have primarily been in regard to electronic position encoders with arc motion and arc shaped encoder track portions, it will be appreciated that certain similar or identical principles may be applied to electronic position encoders with arc motion and linear shaped encoder track portions, and for which the techniques as described herein may be similarly applicable. Some examples of electronic position encoders with arc motion and linear shaped encoder track portions are described in U.S. patent application Ser. No. 18/391,275, filed Dec. 20, 2023, which is hereby incorporated herein by reference in its entirety. Some examples of electronic position encoders with arc motion and arc shaped encoder track portions are described in U.S. patent application Ser. No. 18/391,294, filed Dec. 20, 2023, which is hereby incorporated herein by reference in its entirety. Each of these applications describes certain design principles, which may be utilized in combination with teachings as described herein for forming electronic position encoders with characteristics and operations as described herein.

As used herein, the term “nominally” encompasses variations of one or more parameters that fall within acceptable tolerances. As an example, in one implementation a term such as “nominally” may correspond to a minimal variance from a specified value (e.g., such as a variance of less than 5%, or less than 2%, or less than 1%, such as in accordance with acceptable tolerances, etc.).

It will be appreciated that the principles disclosed and claimed herein may be readily and desirably combined with various features disclosed in the incorporated references. The various implementations described above can be combined to provide further implementations. All of the U.S. patents and U.S. patent applications referred to in this specification are incorporated herein by reference, in their entirety. Aspects of the implementations can be modified, if necessary to employ concepts of the various patents and applications to provide yet further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled.

1. A measuring instrument, comprising:
a movable portion configured to rotate in an arc motion about a pivot portion, the movable portion comprising a movable encoder portion;
an electronic position encoder configured to measure an absolute relative position between a detector portion and a scale portion, wherein the movable encoder portion comprises one of the detector portion or the scale portion, the electronic position encoder comprising:
the scale portion extending along a scale direction, the scale portion comprising:
a first scale element portion comprising first signal modulating scale elements; and
a second scale element portion comprising second signal modulating scale elements; and
the detector portion configured to be proximate to the scale portion with relative movement between the detector portion and the scale portion resulting from the arc motion of the movable encoder portion, the detector portion comprising:
a field generating portion configured to generate changing magnetic flux in response to drive signals; and
a sensing portion comprising:
a first sensing element portion comprising a first set of first sensing elements and arranged in a first track portion with the first scale element portion; and
a second sensing element portion comprising a first set of second sensing elements and arranged in a second track portion with the second scale element portion; and
a signal processing configuration that is configured to:
provide drive signals to cause the field generating portion to generate changing magnetic flux;
receive detector signals from the detector portion, the detector signals comprising:
detector signals from the first set of first sensing elements that operate in conjunction with first signal modulating scale elements; and
detector signals from the first set of second sensing elements that operate in conjunction with second signal modulating scale elements;
based at least in part on the received detector signals, determine an offset value that corresponds to a radial offset of at least one of the scale portion or the detector portion; and
utilize the determined offset value to correct one or more values that are utilized to determine a relative position between the detector portion and the scale portion.

2. The measuring instrument of claim 1, wherein the determining of the offset value comprises determining a chaindown slope.

3. The measuring instrument of claim 2, wherein the chaindown slope is determined from at least one of a direct chaindown process or a double chaindown process.

4. The measuring instrument of claim 3, wherein the chaindown slope corresponds to a chaindown curve plot of chaindown values.

5. The measuring instrument of claim 1, wherein the utilizing of the determined offset value to correct one or more values includes at least in part dividing the determined offset value by at least a radial distance of the first scale element portion from the pivot portion.

6. The measuring instrument of claim 1, wherein the signal processing configuration is further configured to determine an absolute relative position between the detector portion and the scale portion based at least in part on detector signals input from the detector portion, the detector signals including detector signals from the first set of first sensing elements and detector signals from the first set of second sensing elements.

7. The measuring instrument of claim 1, wherein the field generating portion comprises:
a first field generating element portion that is arranged in the first track portion and is configured to operate in conjunction with first signal modulating scale elements of the first scale element portion and the first sensing elements of the first sensing element portion; and
a second field generating element portion that is arranged in the second track portion and is configured to operate in conjunction with second signal modulating scale elements of the second scale element portion and the second sensing elements of the second sensing element portion.

8. The measuring instrument of claim 1, wherein:
the first and second scale element portions of the first and second track portions are arc-shaped and are parallel to each other, with the second track portion closer to the pivot portion than the first track portion;
the first signal modulating scale elements are disposed along the first scale element portion according to a first signal modulating element angular spatial step θ_{WSME1} and the second signal modulating scale elements are disposed along the second scale element portion according to a second signal modulating element angular spatial step θ_{WSME2} that is different than the first signal modulating element angular spatial step θ_{WSME1}; and
the first and second scale element portions define a corresponding absolute angular range θ_{ABS}.

9. The measuring instrument of claim 8, wherein a ratio of the signal modulating element angular spatial steps θ_{WSME2}/θ_{WSME1} can be expressed in accordance with being equal to at least one of the following equations:
$$\begin{matrix}( nm / ( n - 1 ) ) ; \\ ( nm / ( n + 1 ) ) ; \\ ( ( nm + 1 ) / n ) ; \\ ( ( nm - 1 ) / n ) ;\end{matrix}$$
for which n is a positive integer and m is a positive integer that is at least 2.

10. The measuring instrument of claim 8, wherein the absolute angular range θ_{ABS} is equal to one of nθ_{WSME1} or nθ_{WSME2}, where n is a positive integer, and the absolute angular range θ_{ABS} is less than 360 degrees.

11. The measuring instrument of claim 1, wherein θ_{WSME2} is larger than θ_{WSME1}.

12. The measuring instrument of claim 1, wherein:
an operating of the first track portion comprises the first set of first sensing elements providing detector signals which respond to a local effect on a changing magnetic flux provided by first signal modulating scale elements of the first scale element portion; and
an operating of the second track portion comprises the first set of second sensing elements providing detector signals which respond to a local effect on a changing magnetic flux provided by second signal modulating scale elements of the second scale element portion.

13. The measuring instrument of claim 1, wherein:
the first sensing element portion further comprises one or more additional sets of first sensing elements, for which each additional set of first sensing elements has a spatial phase offset relative to the first set of first sensing elements; and
the second sensing element portion further comprises one or more additional sets of second sensing elements, for which each additional set of second sensing elements has a spatial phase offset relative to the first set of second sensing elements.

14. The measuring instrument of claim 1, wherein the first and second signal modulating scale elements comprise conductive plates and the first and second sensing elements comprise conductive loops.

15. A method for operating a measuring instrument,
the measuring instrument comprising:
a movable portion which rotates in an arc motion about a pivot portion, the movable portion comprising a movable encoder portion; and
an electronic position encoder configured to measure an absolute relative position between a detector portion and a scale portion, wherein the movable encoder portion of the moveable portion comprises one of the detector portion or the scale portion, the electronic position encoder comprising:
the scale portion extending along a scale direction, the scale portion comprising:
a first scale element portion comprising first signal modulating scale elements; and
a second scale element portion comprising second signal modulating scale elements; and
the detector portion configured to be proximate to the scale portion with relative movement between the detector portion and the scale portion resulting from the arc motion of the movable encoder portion, the detector portion comprising:
a field generating portion configured to generate changing magnetic flux in response to drive signals; and
a sensing portion comprising:
a first sensing element portion comprising a first set of first sensing elements and arranged in a first track portion with the first scale element portion; and
a second sensing element portion comprising a first set of second sensing elements and arranged in a second track portion with the second scale element portion;
the method comprising:
providing drive signals to cause the field generating portion to generate changing magnetic flux;
receiving detector signals from the detector portion, the detector signals comprising:
detector signals from the first set of first sensing elements that operate in conjunction with first signal modulating scale elements; and
detector signals from the first set of second sensing elements that operate in conjunction with second signal modulating scale elements;
based at least in part on the received detector signals, determining an offset value that corresponds to a radial offset of at least one of the scale portion or the detector portion; and
utilizing the determined offset value to correct one or more values that are utilized to determine a relative position between the detector portion and the scale portion.

16. The method of claim 15, wherein the determining of the offset value comprises determining a chaindown slope.

17. The method of claim 15, further comprising determining a relative position between the detector portion and the scale portion based at least in part on the detector signals input from the detector portion.

18. The method of claim 15, wherein:
the operating of the first set of first sensing elements in conjunction with first signal modulating scale elements includes the first set of first sensing elements providing detector signals which respond to a local effect on a changing magnetic flux provided by first signal modulating scale elements of the first scale element portion; and
the operating of the first set of second sensing elements in conjunction with second signal modulating scale elements includes the first set of second sensing elements providing detector signals which respond to a local effect on a changing magnetic flux provided by second signal modulating scale elements of the second scale element portion.

19. An electronic position encoder configured to measure an absolute relative position between a detector portion and a scale portion and to be utilized in a measuring instrument that comprises a movable portion configured to rotate in an arc motion, the electronic position encoder comprising:
the scale portion extending along a scale direction, the scale portion comprising:
a first scale element portion comprising first signal modulating scale elements; and
a second scale element portion comprising second signal modulating scale elements;
the detector portion configured to be proximate to the scale portion with relative movement between the detector portion and the scale portion resulting from the arc motion of the movable portion, the detector portion comprising:
a field generating portion configured to generate changing magnetic flux in response to drive signals; and
a sensing portion comprising:
a first sensing element portion comprising a first set of first sensing elements and arranged in a first track portion with the first scale element portion; and
a second sensing element portion comprising a first set of second sensing elements and arranged in a second track portion with the second scale element portion; and
a signal processing configuration that is configured to:
provide drive signals to cause the field generating portion to generate changing magnetic flux;
receive detector signals from the detector portion, the detector signals comprising:
detector signals from the first set of first sensing elements that operate in conjunction with first signal modulating scale elements; and
detector signals from the first set of second sensing elements that operate in conjunction with second signal modulating scale elements;
based at least in part on the received detector signals, determine an offset value that corresponds to a radial offset of at least one of the scale portion or the detector portion; and
utilize the determined offset value to correct one or more values that are utilized to determine a relative position between the detector portion and the scale portion.

20. The electronic position encoder of claim 19, wherein the determining of the offset value comprises determining a difference slope.
